(19) United States
(12) Patent Application Publication
(10) Pub. No.: US 2014/0245359 A1
(43) Pub. Date: Aug. 28, 2014

(54) Content Delivery Network Interconnection (CDNI) Mechanism

(71) Applicants: Xavier De Foy, Kirkland (CA); Hang Liu, North Potomac, MD (US); Osama Lotfallah, San Diego, CA (US); Samir Ferdi, Kirkland (CA); Martin Jolicoeur, Dollard-des-Ormeaux (CA); Serhad Doken, Chester Springs, PA (US)

(72) Inventors: Xavier De Foy, Kirkland (CA); Hang Liu, North Potomac, MD (US); Osama Lotfallah, San Diego, CA (US); Samir Ferdi, Kirkland (CA); Martin Jolicoeur, Dollard-des-Ormeaux (CA); Serhad Doken, Chester Springs, PA (US)

(73) Assignee: INTERDIGITAL PATENT HOLDINGS, INC., Wilmington, DE (US)

(21) Appl. No.: 14/123,512

(22) PCT Filed: Jun. 1, 2012
(86) PCT No.: PCT/US2012/040494

§ 371 Date: Apr. 14, 2014

Related U.S. Application Data
(60) Provisional application No. 61/492,336, filed on Jun. 1, 2011.
(60) Provisional application No. 61/497,275, filed on Jun. 15, 2011.

(51) Int. Cl. H04N 21/61; H04W 36/14

(52) U.S. Cl. CPC H04N 21/6181; H04W 36/14
USPC 725/62

(57) ABSTRACT

Embodiments contemplate the movement of mobile node (MN) from a first access network to a second access network, while in communication with a CDN server (e.g. a surrogate providing a multimedia streaming session). The server selection may become sub-optimal as a result of this movement. A first CDN may learn about MN mobility event via the MN, an access network node, the server, or another node. The first CDN may trigger reselection by upstream CDN by sending a CDNI reselection request message, including information for the upstream CDN to perform request routing for the MN with the specified content, at a different location. The upstream CDN may perform the request routing procedure. The upstream CDN may return the request routing result to first CDN. The initial server may send a redirection message back to the application, which may interpret the message and continue streaming from a different server.

### BACKGROUND

Several Adaptive HTTP Streaming solutions are contemplated by the industry generally and by Standard Developing Organizations (SDOs). Examples of industry developed Adaptive HTTP Streaming include but are not limited to: Microsoft Smooth Streaming; Apple Live HTTP Streaming; Akamai Adaptive Video Streaming; and/or Adobes' Dynamic HTTP Streaming

Standards for Adaptive HTTP Streaming may include but are not limited to: 3GP-DASH; MPEG DASH; Live HTTP Streaming; and/or Open IPTV Forum (adopts 3GPP solution and adds support for MPEG-2 TS).

Some or all of these adaptive HTTP Streaming solutions may utilize a manifest file (e.g. an XML-based Media Presentation Description file in DASH) that may be distinct from media file(s) (e.g. format extended from the ISO Base Media File Format). The media may be accessed by units (e.g., called segments in DASH and other standards); and/or each segment may be obtained using the HTTP GET method (or a POST as the in the Akamai's streaming solution, for example).

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Embodiments contemplate that a CDN 1 may request a CDN re-selection to an upstream CDN. Upon reception of the response from the upstream CDN, the CDN 1 may redirect the client to the new (e.g., a different or an updated) surrogate.

Embodiments contemplate that a CDN 1 may perform the reselection to CDN 2 and may redirect the client there (upstream CDN may be informed or may also be part of the procedure).

Embodiments contemplate that a CDN 1 may redirect the client towards the origin server (where a new/different/updated CDN/surrogate selection may be performed).

Embodiments contemplate that a CDNI API may provide heretofore unutilized messages related to content delivery CDN reselection, such as: a reselection request (and associated response) may be used to ask for an active role in reselection; a reselection indication (and associated ack) may be used to inform about a reselection; and/or one or the other or both may be used depending on the embodiment.

Embodiments contemplate that a reselection may require heretofore un-contemplated support from one or more surrogates and clients for redirection mechanisms for the different families of streaming protocols such as: adaptive HTTP streaming and/or progressive HTTP download.

Embodiments contemplate that mobility and/or quality of experience degradation detection may be addressed by various techniques under the control of a single CDN provider (e.g. signaling between mobility infrastructure and CDN, etc.). For example, embodiments contemplate that caches may register for mobility events with a network based detection function, for example collocated with a MIP home agent.

Embodiments contemplate interfaces between CDNs (CDNI), and between CDNs and Mobile Nodes (for redirection)—internal procedures inside CDNs can for example be addressed by extending existing proprietary signaling. As a result, CDNs may be represented as single entities in message flows even if actually several CDN nodes may be involved, for example.

Embodiments contemplate one or more CDNI Request Routing procedures (e.g., the request routing procedure run to choose a CDN to deliver content).

Embodiments contemplate one or more methods that may comprise detecting movement of a mobile node (MN) from a first access network to a second access network. The MN may be in communication with a first content delivery network (CDN-1) server. The CDN-1 server may be in communication with a first content delivery network (CDN-1). The method may further include determining an effect on server selection as a result of the movement and initiating a transfer from the CDN-1 server to a second content delivery network (CDN-2) server, based at least in part, on the determination of the effect the server selection the CDN-2 server being in communication with a second content delivery network (CDN-2).

Embodiments contemplate that the determining the effect on server selection may include a comparison of a measured quality of service with a predetermined quality of service and that the initiating the transfer may be further based on the measured quality of service being less than the predetermined quality of service. Alternatively or additionally, embodiments contemplate that the determining the effect on server selection may include a comparison of an estimated cost of delivery to a predetermined cost of delivery.

Embodiments contemplate that prior to the transfer the MN may receive an application stream via the CDN-1 server and the transfer may include redirecting the application stream to the MN via the CDN-2 server. Alternatively or additionally, embodiments contemplate the one or more methods may include sending a first message to the CDN-2. The first message may include a request for an updated routing for the application stream. Embodiments also contemplate the methods may include receiving a second message from the CDN-2. The second message may include an updating routing for the application stream. Also, embodiments contemplate that the initiating the transfer may include sending a third message to a source of the application stream. The third message may include the updated routing information for the application stream.

Embodiments also contemplate that the CDN-1 and the CDN-2 may be in communication with a third content delivery network (CDN-3), and the methods may further comprise sending a fourth message to the CDN-3. The fourth message may include an indication of the transfer. The methods may also include receiving a fifth message from the CDN-3. The fifth message may include an acknowledgment of the indication of the transfer.

Alternatively or additionally, embodiments contemplate that the methods may further comprise sending a first message to the CDN-3. The first message may include a request for an updated routing for the application stream. Embodiments contemplate that the methods may include receiving a second message from the CDN-3. The second message may include an updating routing for the application stream. Embodiments also contemplate that the initiating the transfer may include sending a third message to a source of the application stream, where the third message may include the updated routing information for the application stream.

Alternatively or additionally, embodiments contemplate that the initiating the transfer may include sending at least one command for an application specific transfer. Embodiments contemplate that the application may include at least one of Adaptive Hyper Text Transport Protocol (HTTP) Streaming, Real Time Streaming Protocol (RTSP), or HTTP Progressive Download streaming.

One or more embodiments contemplate one or more methods that may comprise detecting movement of a mobile node (MN) from a first access network to a second access network. The MN may be in communication with a first content delivery network (CDN-1) server, and the CDN-1 server may be in communication with a first content delivery network (CDN-1). Embodiments contemplate that the methods may include determining an effect on server selection as a result of the movement. Further, embodiments contemplate that the methods may include initiating a transfer from the CDN-1 server to an application server, based at least in part, on the determination of the effect the server selection. The MN may receive an application stream from the application server via the CDN-1 server prior to the transfer.

Alternatively or additionally, embodiments contemplate that the CDN-1 may be in communication with a second content delivery network (CDN-2), and the methods may further comprise sending a first message to the CDN-2. The first message may include a request for an updated routing for the application stream. Embodiments also contemplate that the methods may include receiving a second message from the CDN-2. The second message may include a redirection to the application server.

Embodiments contemplate systems and methods to enable a Mobile Node (MN) to continue streaming from an optimal surrogate (e.g., “optimal” may mean an appropriate surrogate as determined by the delivery network(s)) after moving to another access network. The newly/freshly selected or identified surrogate may be a different surrogate within the same CDN or a surrogate from another CDN. In one or more embodiments, the systems and methods enable continuity and optimized surrogate selection regardless of the CDN used, and regardless whether Mobile IP (MIP) is used or not.

In one or more embodiments, the mobile node (MN) (which may be a user equipment (UE) or wireless transmit/receive unit (WTRU)) may include a client application-based solution that performs one or more of the following: Proper selection of a CDN surrogate when starting a new/different streaming session; Proper re-selection of a CDN surrogate when moving from an access network to another, with support for session continuity; Support of any CDN request routing method; Support Mobile Nodes using MIP or not using MIP (e.g. nomadic laptop without MIP stack); Do not negatively impact Proxy Mobile IP (PMIP) when PMIP may be used; Extension of the disclosed methods to aggregate streams over several access networks, using properly selected surrogates over each access network; and/or various types of handover (hard handover and soft handover) may be supported.

In one or more embodiments comprise: receiving content at a mobile node from a first surrogate server of a content delivery network (CDN); receiving a network attachment notification associated with the mobile node's network attachment; responsively initiating a CDN surrogate selection to identify a second surrogate server; and, receiving content at the mobile node from the second surrogate server. The first surrogate server may be identified using a domain name service. In addition, the network attachment notification may be a network attachment event generated by a protocol stack of the mobile node, or it may be a handoff indication, or a detection of a second network attachment. Furthermore, the first surrogate server and the second surrogate server may be identified using domain name service (DNS). In some embodiments, the domain name service may be invoked with a DNS server associated with a specific network attachment, or it may be invoked with a DNS server address parameter. The domain name service may be invoked with an indication to not use a DNS cache, and/or the domain name service may provide a local cache with entries having local/global indicator parameter.

One or more embodiments comprise: establishing a plurality of network attachments to a plurality of networks over a corresponding plurality of network interfaces of a mobile node; for each of the plurality of network interfaces, initiating a CDN surrogate identification process and receiving corresponding CDN surrogate server addresses; requesting a plurality of portions of content via the plurality of network interfaces using the corresponding CDN surrogate server addresses; and, receiving and aggregating the plurality of portions of content. The method may further comprise: receiving a network attachment notification associated with at least one of the plurality of the mobile node's network attachments; and responsively initiating a CDN surrogate selection.

One or more embodiments contemplate an apparatus, where the apparatus may comprise: a wireless network interface device having a communications protocol module configured to establish a network attachment to a wireless network; a streaming module configured to receive a content delivery network (CDN) surrogate server address and request portions of media content using the wireless network interface and the CDN surrogate server address; and a connection manager component configured to detect a network attachment notification associated with the wireless network interface device and to responsively initiate a CDN surrogate identification process. The connection manager may be configured to initiate a CDN surrogate identification process by requesting the streaming module to initiate a domain name service (DNS) request for a name associated with the portions of media content. Further, the apparatus may be configured such that the DNS request is invoked with a DNS server address parameter, and/or the DNS request is invoked with an indication to not use a DNS cache, and/or where the domain name service provides a local cache with entries having local/global indicator parameter.

The apparatus may further comprise a plurality of wireless network interface devices, each of the plurality of wireless network interface devices having at least one associated streamer module, and wherein each streamer module is configured to use a CDN surrogate server address associated with its respective network interface. Further, it may also comprise a scheduler module configured to allocate requests for portions of media content to the least one associated streamer module for each wireless network interface device.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and an example core network that may be used within the communications system illustrated in FIG. 1A;

FIG. 1E is a system diagram of another example radio access network and an example core network that may be used within the communications system illustrated in FIG. 1A;

FIG. 2 illustrates a diagram of an exemplary CDN Interconnection area consistent with embodiments;

FIG. 3 is an illustrative legend that may be used in one or more of the figures consistent with embodiments;

FIG. 4 illustrates an example of Redirection Mechanism for DASH (URL Rewriting) consistent with embodiments;

FIG. 5 illustrates an example of Redirection Mechanism for DASH (DNS redirection) consistent with embodiments;

FIG. 6 illustrates of an Example of Redirection Mechanism for DASH (HTTP redirection) consistent with embodiments;

FIG. 7 illustrates a Legend that may be Applicable to one or more of the other Figures consistent with embodiments;

FIG. 8 illustrates a basic Scenario when CDNI is used in a manner consistent with embodiments consistent with embodiments;

FIG. 9 illustrates an example where a surrogate selection becomes sub-optimal after a Mobility Event consistent with embodiments;

FIG. 10 illustrates an exemplary Session Transfer from one device to another consistent with embodiments consistent with embodiments;

FIG. 11 illustrates a CDNI Reselection Following a MN Mobility Event consistent with embodiments consistent with embodiments;

FIG. 12 is an example of String substitution based redirection consistent with embodiments consistent with embodiments;

FIG. 13 illustrates an RTSP Redirection between surrogates consistent with embodiments;

FIG. 14 illustrates an example of redirection using Progressive HTTP Download consistent with embodiments consistent with embodiments;

FIG. 15 illustrates an example of CDN 1 is the authoritative CDN variant of the embodiment depicted in FIG. 11 and consistent with embodiments;

FIG. 16 illustrates an example of CDN 2 is the authoritative CDN variant of the embodiments depicted in FIG. 11 and consistent with embodiments;

FIG. 17 illustrates an exemplary Reselection Request Sent to Peer CDN consistent with embodiments;

FIG. 18 illustrates an example of reselection via a client consistent with embodiments;

FIG. 19 illustrates and example Redirection for Client Based Reselection with adaptive HTTP streaming (DASH) consistent with embodiments;

FIG. 20 illustrates an example Redirection for Client Based Reselection with Progressive HTTP Download consistent with embodiments;

FIG. 21 is an exemplary message flow diagram for DNS address resolution in a CDN consistent with embodiments;

FIG. 22 is an alternate exemplary message flow diagram for DNS address resolution in a CDN consistent with embodiments;

FIG. 23 is an alternate exemplary message flow diagram for DNS address resolution in a CDN consistent with embodiments;

FIG. 24A is an exemplary depiction of CDN-related connections in a mobile environment that does not provide re-negotiation of surrogate servers consistent with embodiments;

FIG. 24B is an depiction of CDN-related connections in a mobile environment that provides re-negotiation of surrogate servers according to various embodiments described herein;

FIG. 25 is an exemplary depiction of CDN-related Mobile IP connections in a mobile environment that does not provide re-negotiation of surrogate servers;

FIG. 26 is an exemplary depiction of CDN-related Mobile IP connections using Mobile IP route optimization in a mobile environment that does not provide re-negotiation of surrogate servers consistent with embodiments;

FIG. 27 depicts various exemplary cases where continuity during an inter-access handover or stream aggregation across multiple access networks is provided consistent with embodiments;

FIG. 28 is an exemplary embodiment of a streaming client apparatus configuration consistent with embodiments;

FIG. 29 is an exemplary embodiment of a streaming client apparatus configuration during handoff consistent with embodiments;

FIG. 30 is a flow diagram in an Application Layer Session Continuity exemplary scenario consistent with embodiments;

FIG. 31 is an exemplary streaming client apparatus configuration during aggregation consistent with embodiments;

FIG. 32 is a flow diagram in an Application Layer Session Aggregation and Continuity exemplary Scenario including mobility consistent with embodiments; and

FIG. 33 is a flow diagram in a Progressive HTTP Download Application Level Session Continuity exemplary scenario.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application. As used herein, the articles “a” and “an”, absent further qualification or characterization, may be understood to mean “one or more” or “at least one”, for example.

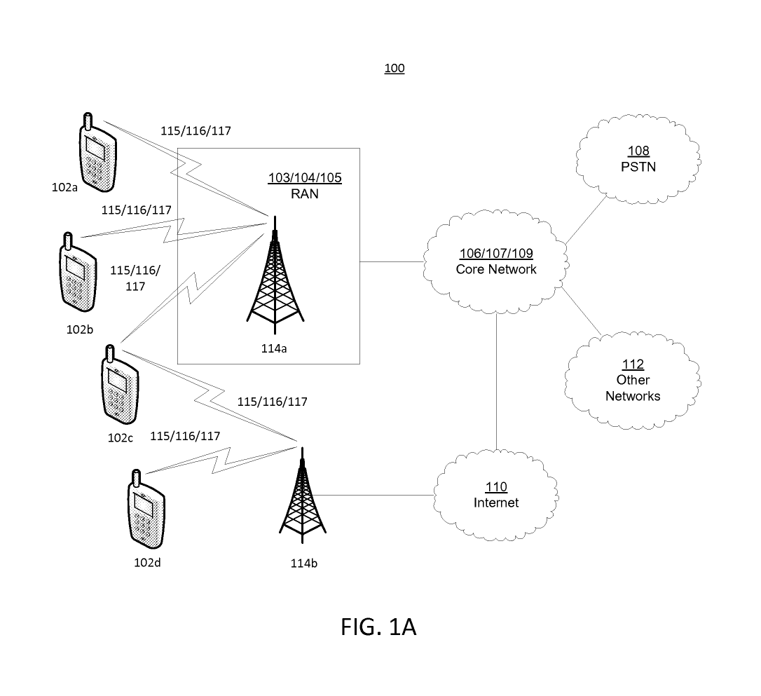

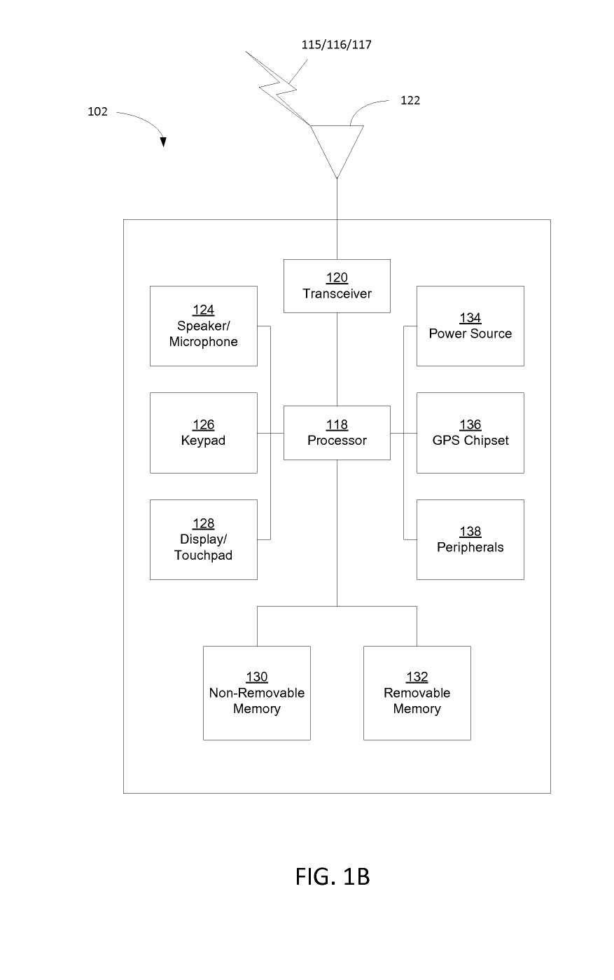

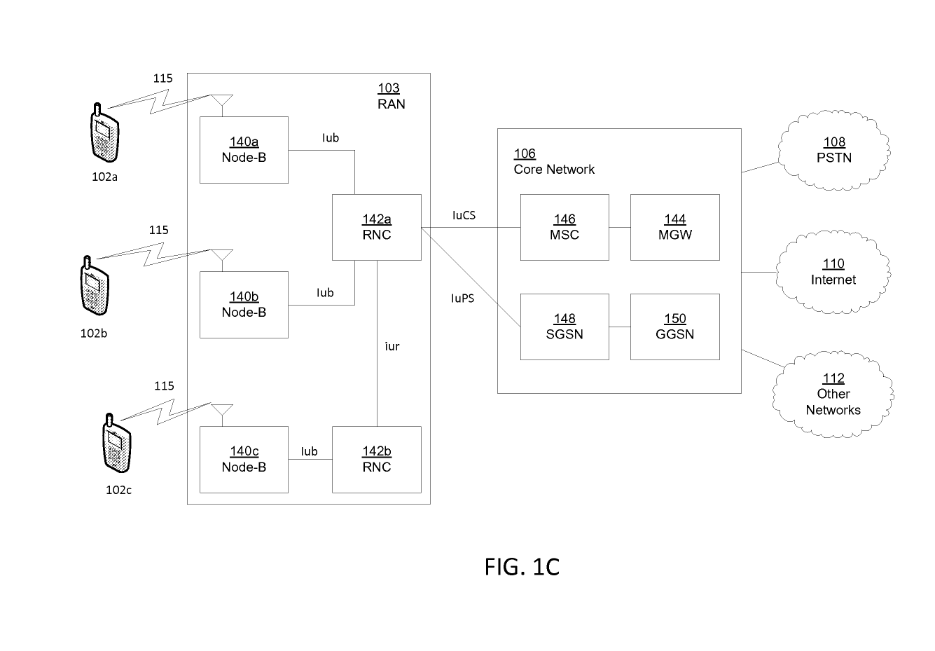

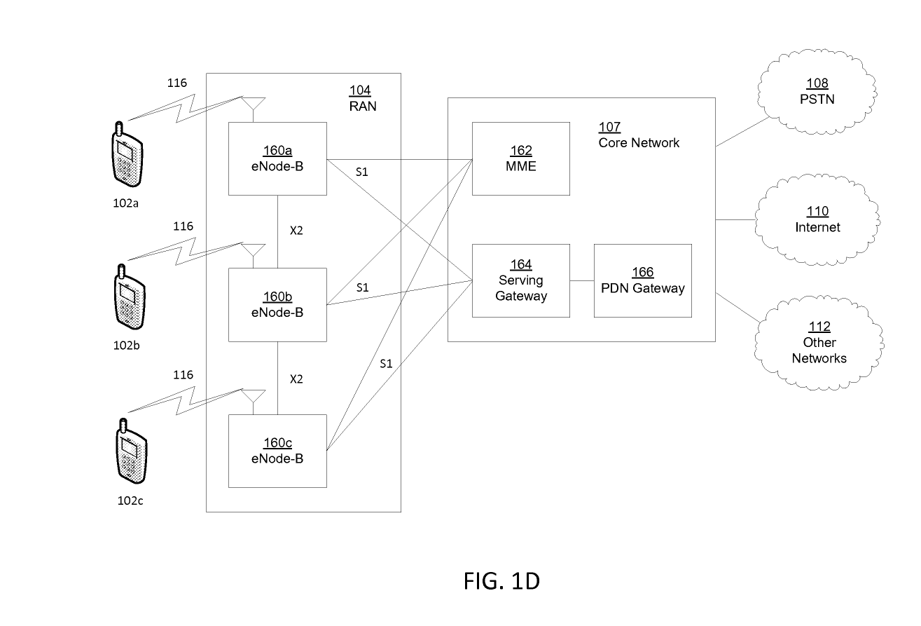

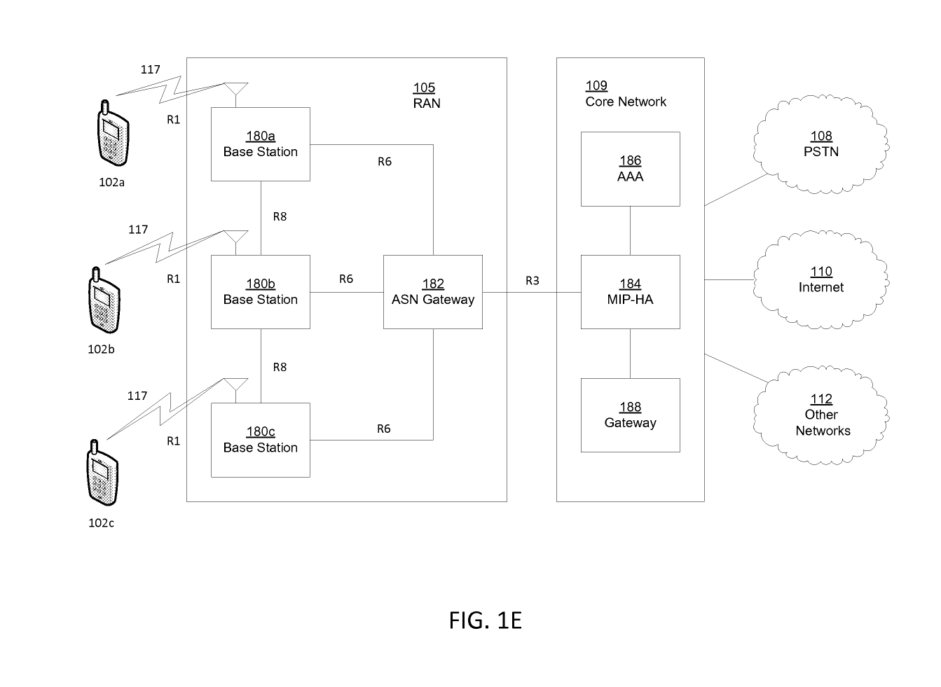

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an RI reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although not show in FIGS. 1C-1E, each of the above networks, as well as 802.11-based networks, include a domain name service (DNS) with one or more DNS servers.

Embodiments contemplate that multimedia streaming may be conducted in at least three forms: RTSP/RTP streaming, HTTP progressive download, and/or Adaptive HTTP Streaming. For example, the 3GPP transparent end-to-end Packet-switched Streaming Service (PSS) supports all three types of the aforementioned streaming protocols.

Embodiments recognize that the Real Time Streaming Protocol (RTSP) may be a network control protocol used with streaming media servers. RTSP may be used to establish and control media sessions between end points, for example. Clients of media may issue VCR-like commands such as play and pause, for example. RTSP may be used along with Real-Time Transport Protocol (RTP) for media stream delivery.

HTTP progressive download may include downloading a multimedia file typically using HTTP chunked transfer encoding, and start playback when at least a part of the file is downloaded. From such a point on, file download and playback may be performed in parallel.

Embodiments contemplate that Content Delivery Networks may host third party content for efficient (e.g., fast) delivery of static content, streaming media, and varying content services.

In the particular case of streaming media, embodiments contemplate that a content request from a client node may result in the selection of a surrogate that may be able to serve streaming content.

Embodiments contemplate one or more methods used by CDNs to perform content redirection (also known as Request Routing for purposes of explanation and not limitation). One or more embodiments may include using special DNS servers, application layer redirection, and/or content modification (URL rewriting) sometimes in combination. In addition, CDN Interconnection may enable content redirection to cross CDN boundaries.

From a media streaming client stand point, embodiments contemplate that the surrogate selection process may be transparent to the client application (except perhaps in one or more embodiments such as with HTTP redirection, where application redirection support may be used). The surrogate selection may occur at various points in time in the media streaming session establishment, perhaps, in one or more embodiments, depending on the request routing method used by the CDN (e.g. during the DNS request, or while fetching metadata). Moreover, in one or more embodiments, the surrogate may not be re-selected during the media session.

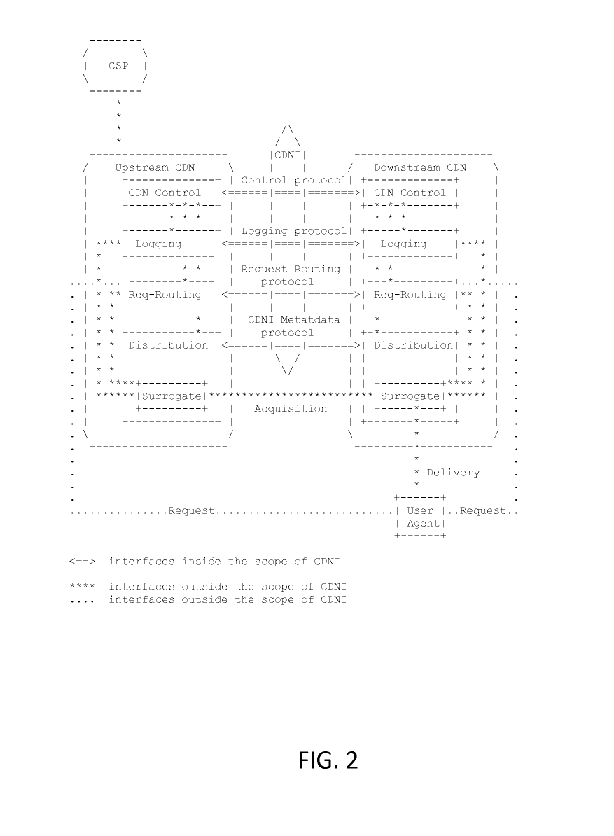

FIG. 2 illustrates a diagram of an exemplary CDN Interconnection area contemplated by embodiments.

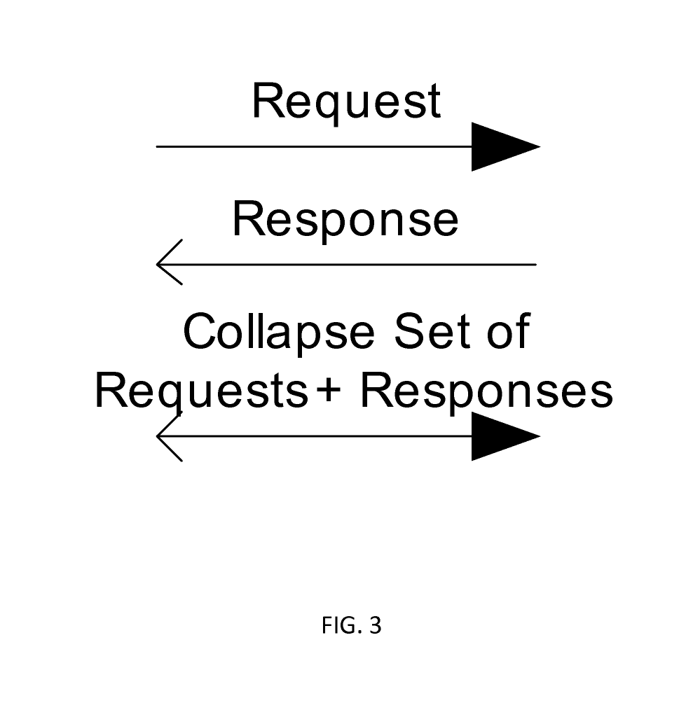

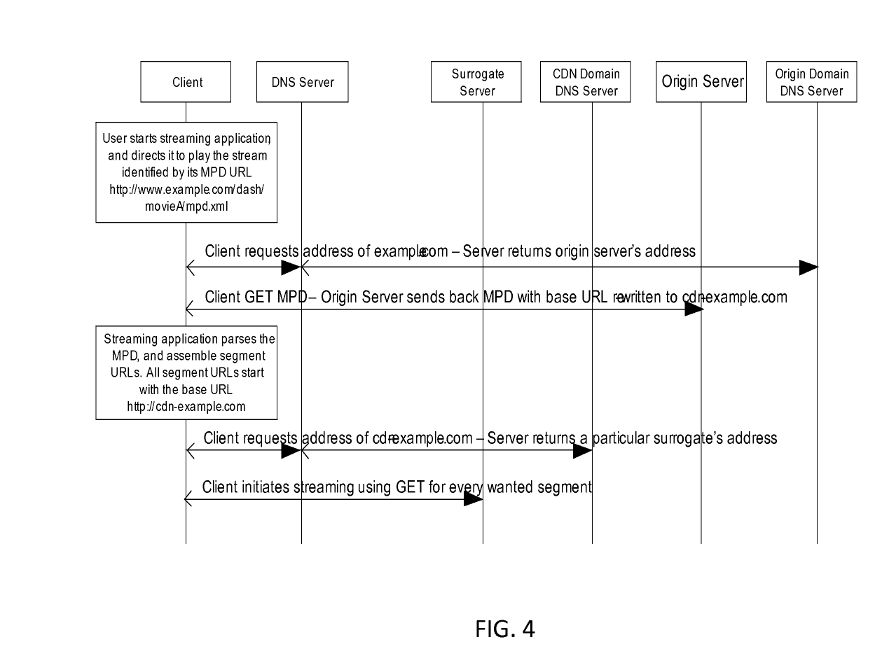

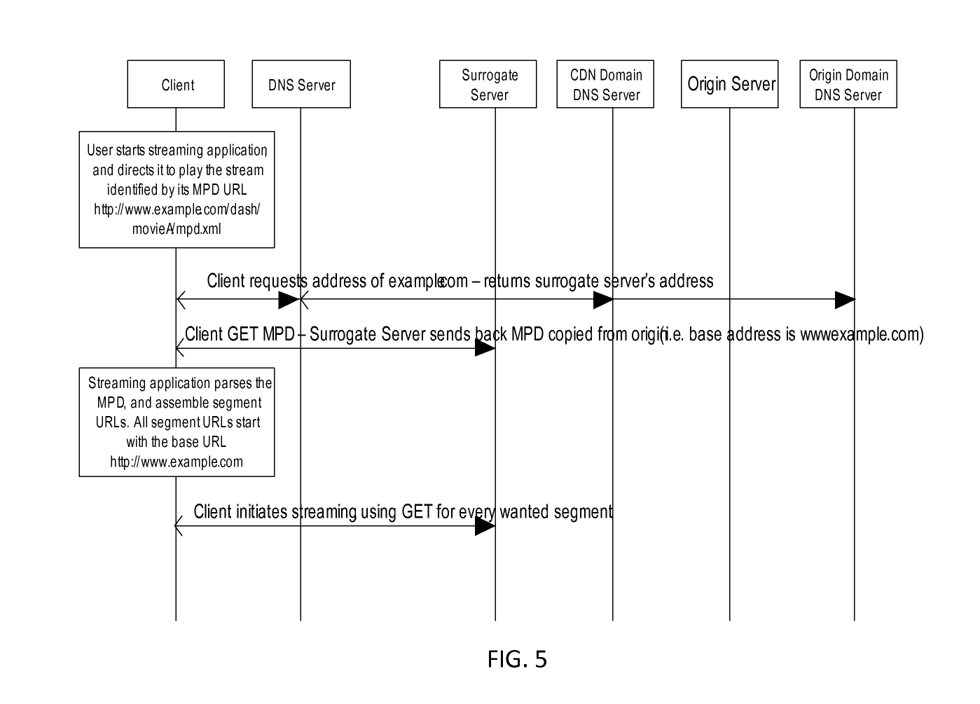

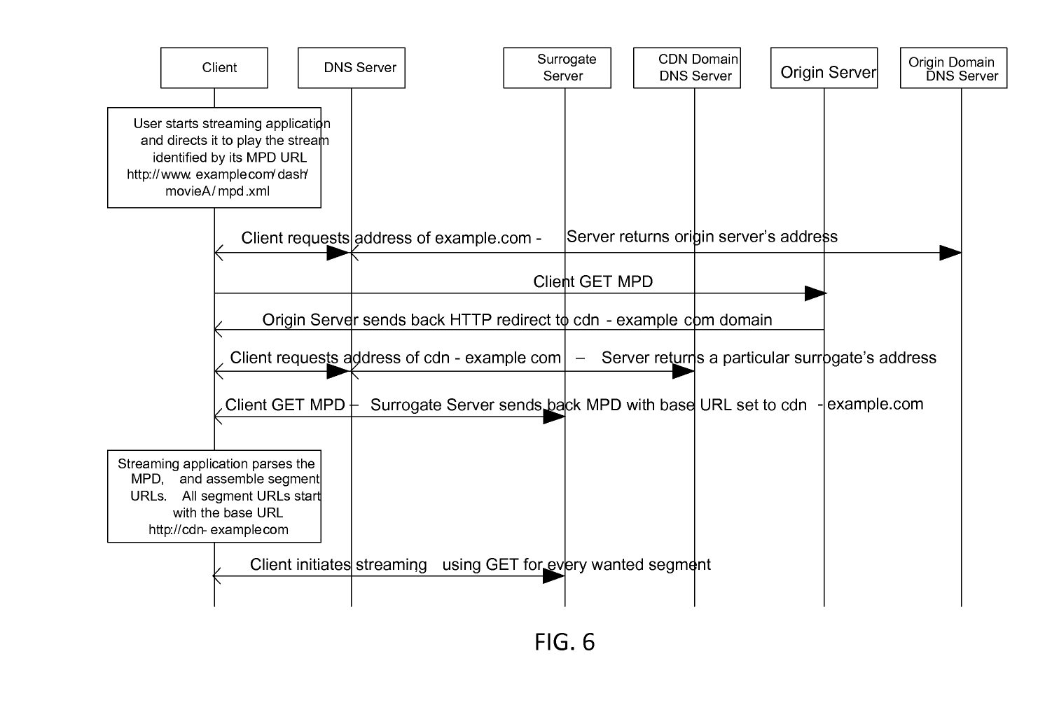

FIG. 3, FIG. 4, FIG. 5, and FIG. 6 illustrate one or more contemplated techniques for a streaming client to be redirected to a surrogate to download adaptive HTTP streaming segments.

In FIG. 4, the origin server may be dynamically rewriting URLs in the stream metadata, to point to the appropriate surrogate. (Note that additional DNS servers, such as root servers, may be involved in the DNS procedures, but are not represented.)

In FIG. 5, DNS redirection may be used. In FIG. 6, HTTP redirection may be used.

Embodiments contemplate that other redirection mechanisms may be used as well. FIGS. 3-6 illustrate how contemplated redirection methods could be used for DASH, but other streaming protocols can be redirected in a similar way. Also, different CDNs may implement different redirection mechanisms.

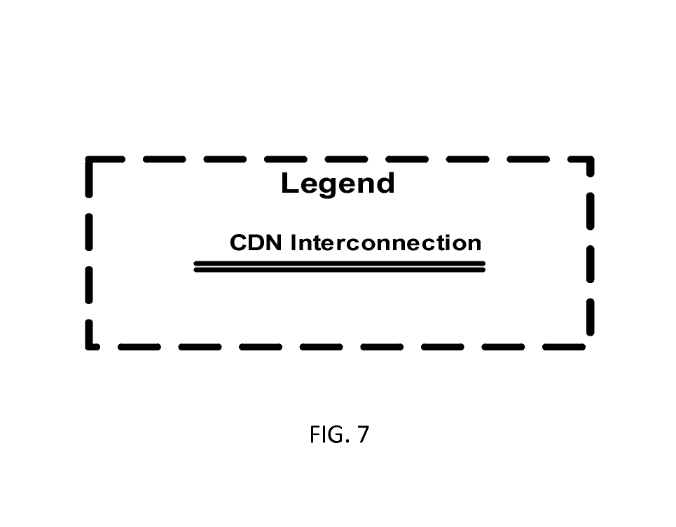

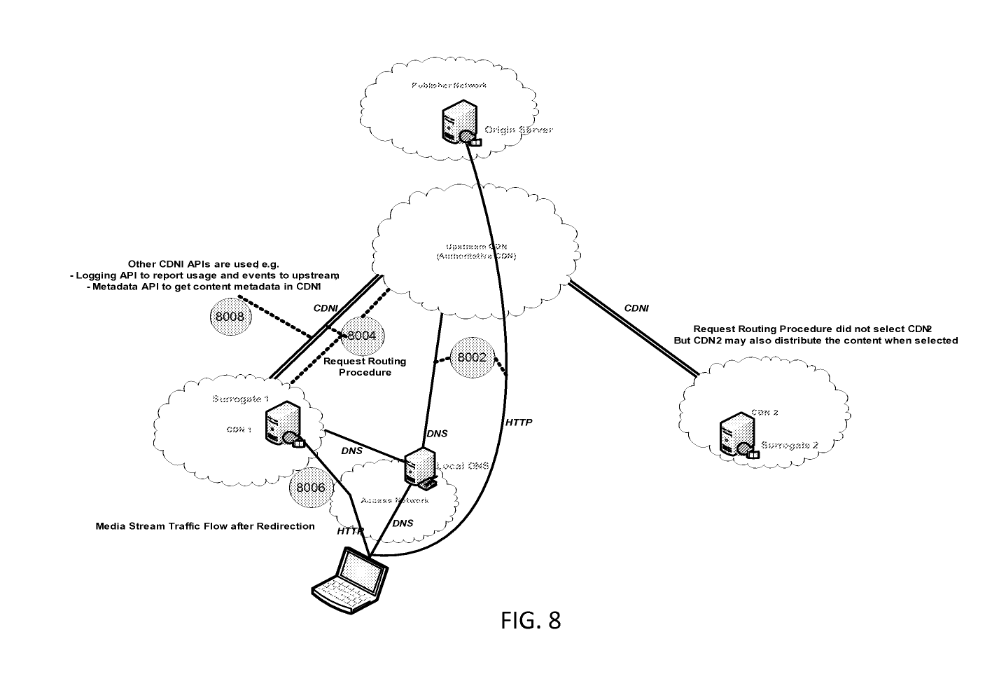

FIG. 7 illustrates a legend that may apply to one or more of the other figures regarding CDN interconnection. FIG. 8 illustrates a scenario when CDNI is used that is contemplated by embodiments. This scenario of FIG. 8 involves content delivered using a CDN. In FIG. 8, the publisher may have a business relationship with a CDN (e.g., an authoritative CDN for this publisher's content). The authoritative CDN may delegate some or all delivery to downstream CDNs. Embodiments contemplate that different redirection methods may be implemented by different CDNs. In FIG. 8, a DNS redirection method is represented for illustrative purpose.

In FIGS. 8, at 8002 and 8004, a client node accesses a web page on the origin server. This web page may point to content delivered by a CDN (e.g., the Authoritative CDN for this content). The client node may perform DNS name resolution for this content. The request reaches the authoritative CDN's DNS server(s), which may trigger a request routing procedure. During this procedure the authoritative CDN may use the CDNI interface, and may select CDN 1. The DNS query procedure may involve the local DNS server of the client node, DNS Server(s) in the authoritative CDN, and/or DNS Server(s) in CDN 1 (and perhaps root DNS servers as well, which is not represented). Also, a DNS response holding the IP address of the selected surrogate in CDN 1 may be returned to the client.

Embodiments contemplate that different variants of this initial surrogate selection may be implemented by different CDNs. An illustrative common point may be to use a CDN interconnection interface in the request routing process.

At 8006, perhaps upon reception of the DNS response, the client node application may start streaming from the CDN 1 surrogate.

At, 8008, the CDN Interconnection interface may be used to transfer information related to the media session between CDN 1 and the authoritative CDN (using metadata and logging CDNI APIs in particular, for example).

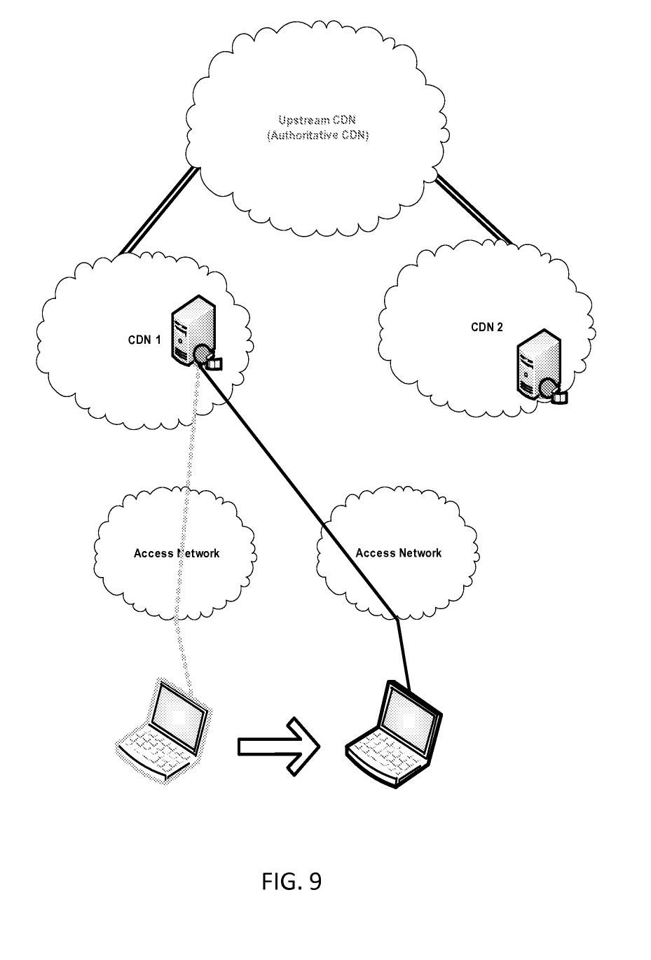

FIG. 9 illustrates an example of where a surrogate selection may become sub-optimal after a Mobility Event. A client application running on a Mobile Node may be streaming from a surrogate server in CDN1. The Mobile Node may move to another access network. This second access network may be better served by a surrogate in CDN 2 (e.g., if the client started a new/different streaming session when connected through this second access network, a surrogate in CDN 2 may be selected by the upstream CDN). Embodiments contemplate at least two scenarios or use cases based on FIG. 9—which may be considered individually or in combination.

In at least one contemplated use case (case 1—the numerical use case being used for purposes of explanation and not limitation) (e.g., Movement Detection), after the movement to the new/different access network, CDN 1 may detect that the Mobile Node moved to a new/different location (for example, CDN 1 surrogate may be informed by the Mobile Node itself, or CDN 1 surrogate may detect that the Mobile Node IP address is outside of a given IP address range). Within CDN 1, a node may decide that this new/different location is outside of a proper delivery zone (e.g., CDN 1 accepted to deliver the content to the MN at the previous location, but decides that it is not well suited to deliver to the new/different location). In order to reduce the risk to provide a low quality of service (which may be reported and may penalize CDN 1 business relationships), CDN 1 may decide to trigger a reselection of the serving surrogate.

Embodiments contemplate that CDN 1 can perform this reselection internally. In one or more embodiments, it may be assumed that CDN 1 decides that none of its surrogates may be likely to provide the required service, and thus may decide to trigger a new/different CDN reselection, using one or more of the embodiments described herein.

In at least a second case (use case 2—again the numerical reference presented for purposes of explanation and not limitation) (e.g., Quality of Experience Detection), after the movement to the new/different access network, the CDN 1 surrogate may continue to be used. A monitoring of the quality of the delivery may be performed at some points in time or perhaps continuously (or at all times) by CDN 1 surrogates (such monitoring may include network measurements, as well as quality of experience feedback from end users). The monitoring may show that the quality of the delivery is lower than a given threshold. For this or other reasons, the CDN 1 may decide to trigger a reselection of the serving surrogate.

In one or more embodiments related to case 2, CDN 1 may perform this reselection internally. One or more embodiments also contemplate that CDN 1 may decide that none of its surrogates are likely to provide the required service, and thus may decide to trigger a new/different CDN reselection, using one of the embodiments described herein.

Embodiments contemplate that the Quality of Experience detection may trigger a decision for reselection, perhaps even when no mobility event occurs. For example, if a network degradation occurs then it may be useful to select a new/different surrogate, perhaps as long as this surrogate may be likely to provide a better Quality of Experience.

For purposes of illustration and not limitation, node movement (for example that of use case 1) will be represented as the cause of the reselection in one or more further described embodiments. However, one or more of the embodiments described wherein contemplate that Quality of Experience degradation is also a valid cause for reselection.

Embodiments contemplate that another related use case is to have a multimedia session moved by an end user from a device to another (e.g. laptop to a Smartphone). This operation may involve moving an application session from one access network to another.

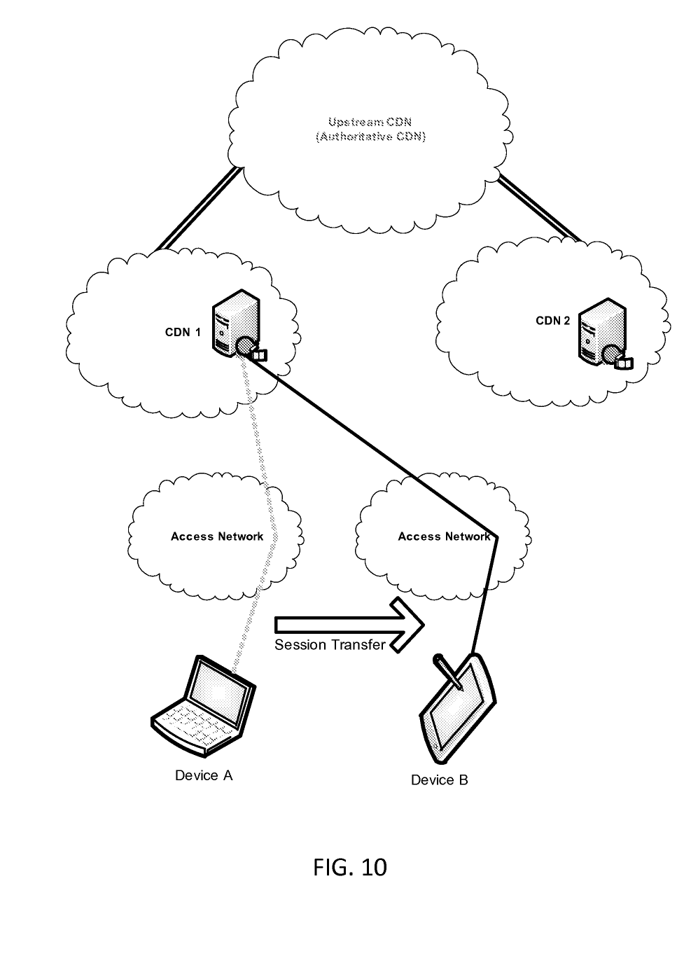

FIG. 10 illustrates an exemplary session transfer from one device to another. This inter-device session mobility is consistent with, for example, IMS Inter UE (or Wireless transmit/receive unit (WTRU)) Session Transfer (IUT), solutions contemplated for RTSP session transfer.

Embodiments contemplate that that some types of session transfers (for example, schemes where device B is communicated a bookmark where to resume the session and where B initiates a new/different session before using the bookmark) may result in an optimal CDN/surrogate selection (perhaps because device B starts a brand new/different content delivery session, and so the CDN selection can take place). But some other methods such as the transfer of an RSTP session can result in continued use of the same surrogate after the transfer. One or more embodiments consider this second class of transfer.

After the transfer is performed, if the transfer results in a non-optimal surrogate being used, the situation is similar to the single device mobility case described herein. Embodiments contemplate that Use Case 1 and/or Use Case 2 described previously may apply at this point.

Referring again to FIG. 8, FIG. 8 illustrates an embodiment that is related to a media streaming session. One or more embodiments contemplate: Adaptive HTTP streaming, for example DASH; RTSP based streaming; and/or Progressive HTTP Download.

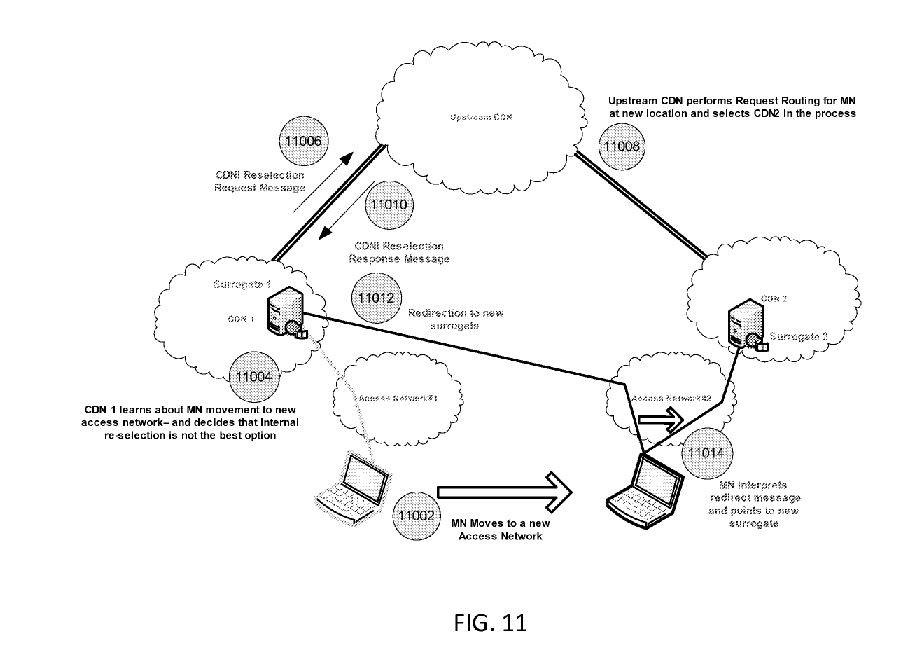

Embodiments such as those illustrated in FIGS. 11, 15, 16, 17, and/or 18 contemplate that MN movement information may reach CDN 1, which may initiate the CDN reselection. One or more embodiments contemplate that CDN 1 could decide to select a new/different surrogate within CDN 1 itself. For purposes of explanation, and not limitation, one or more illustrated embodiments may assume that CDN 1 decides it may not be the best suited to deliver the content to the new/different location, and so decides to refer to the upstream CDN for the reselection decision. In one or more embodiments, instead of detecting the movement itself, CDN 1 may also detect Quality of Experience degradation for the end user.

FIG. 11 illustrates an exemplary CDNI Reselection Following a MN Mobility Event. At 11002 and 11004, a mobile node may move from access network #1 to another access network #2, while in communication with a CDN surrogate (e.g. during a multimedia streaming session). The surrogate selection may become sub-optimal as a result of this movement. CDN 1 may learn about MN mobility event. The source of the event may be the MN, an access network node, the surrogate server, and/or another node. The CDN 1 node may make the decision to either process this event internally (e.g., no action, or move to another surrogate), or it may also decide that with the new delivery conditions, CDN 1 may not be able to maintain the level of service for the end user. Rather than degrading the user experience, CDN 1 may decide to let the upstream CDN reselect a better suited (perhaps a “best”) CDN to delegate delivery to.

Embodiments contemplate that CDN 1 may for example, have an agreement to deliver content with a given quality of service. In one or more embodiments, CDN 1 may implement the techniques to detect that a content consumer leaves its target delivery zone, perhaps in order to guarantee delivery QoS.

At 11006, CDN 1 may trigger reselection by upstream CDN, by sending a CDNI reselection request message. The message may include enough information for the upstream CDN to perform request routing for the MN with the specified content, at the new/different location.

At 11008, the upstream CDN may perform the request routing procedure.

At 11010, the upstream CDN may return the request routing result to CDN 1, using a CDNI reselection response message, for example.

At 11012 and 11014, perhaps as a result, the initial surrogate server may send a redirection message back to the application, which may interpret it and continue streaming from the new/different surrogate. In one or more embodiments, this redirection mechanism may be application specific. Embodiments contemplate mechanisms for Adaptive HTTP Streaming, RTSP, and/or Progressive Download.

Embodiments contemplate heretofore unutilized control messages, which may be for example encoded using XML over HTTP. In one or more embodiments, the message may contain one or more of the following fields.

Embodiments contemplate a Request. The Request may include an Identifier of the session to reselect, which may include one or more of: an end user identification (for example a token (such as a cookie) acquired by the end user device, proof of identity, and granting access to content—or an initial IP address of the Mobile Node; a content identification (such as URL of content on origin server, e.g. Media Presentation Description (MPD) URL in the case of DASH, or another unique name, for example); and/or a content delivery session ID that may be an identifier uniquely describing the particular instance of the content delivery session being subject to reselection (for example this identifier may have been allocated by the authoritative CDN during the initial request routing procedure). For example, a User at IP address IP 1 requested content C at date/time T—the particular delivery instance could be identified with an ID IP1-C-T.

The Request may also include Information enabling request routing to be performed, which may include one or more of: a new/different IP address of the Mobile Node; Additional location information (WLAN SSID, domain name, primary/secondary location DNS server addresses, etc., for example) which can help the selection; Content version identification (for example an incremental version number, or a hash value calculated over content data files, etc.), in some embodiments the version may be useful to prevent reselection for a content which may now obsolete; No reselection flag which may be an indication whether CDN 1 may be willing to be reselected for the content (e.g. if CDN 1 is experiencing difficulties to deliver, it may want to prevent any new/different selection for this particular content delivery).

The Request may also include Additional information may be added to help in the reselection decision, which may include at least one of: a Reselection Reason (e.g. Quality of Experience degradation or Mobility Event); a Current Quality of Experience measurements (e.g. round trip, bandwidth, current bit rate in case of adaptive streaming); a Target Quality of Experience (e.g., what may be the level of service CDN 1 originally accepted to deliver). For example, this target can be used as a threshold for reselection—perhaps if no other CDN are able or willing to achieve this level of quality, then no reselection may occur; a New/different access network type and bandwidth capacity (this can help limiting acquisition to certain encoded bitrates for example); and/or a Current position in the stream (this may be useful to limit acquisition to a portion of the content, for example).

Embodiments contemplate a Response. The response may include a Content delivery session ID and/or request message ID (to match response with request, for example). The Response may include a Response code. Embodiments contemplate that a response code (e.g., a valid response code) may include one or more or of : a Reselection performed (use attached URL for redirection); an Ask CDN 1 to continue delivering with degraded performance; an Ask CDN 1 to stop delivering (CDN 1 may then indicate the reason for stopping the delivery in an error message, e.g. HTTP 5xx code. In one or more embodiments, the client application may present the cause of the problem to the end user.); an Ask CDN 1 to perform the reselection using another method (such as one of the other embodiments presented in this document, e.g., redirect to origin server or redirect downstream CDN).

For example, the upstream CDN may decide to send a “continue” or “stop” code, perhaps if the same delivery was re-selected several times in a short period, to avoid degrading the user experience from too many changes in delivery quality. One or more embodiments contemplate that, perhaps when applicable, a Response may include an identifier of the new/different content location, such as a URL, for example.

Embodiments contemplate Redirection of adaptive HTTP streaming session (which for purposes of explanation—and not limitation may be referred to as alternative 1). Embodiments contemplate that client application redirection for adaptive HTTP streaming such as DASH can be performed using an HTTP redirect message (3xx code for example).

Since the current surrogate may be aware of the destination URL, contemplated redirection techniques may include a string based substitution mechanism, which includes redirecting the client application to the requested segment on the new/different surrogate. In one or more embodiments, the client application may reconstruct some or all following segments using this redirection as a template.

For example, http://domain1/path1/abc/segment12.ts may be redirected to http://domain2/path2/abc/segment12.ts. Potentially ignoring the longest common suffix string (/abc/segment12.ts)—The remaining part may be http://domain1/path1, which may become http://domain2/path2. From this point further, at some times, or perhaps every time, the client application may need to fetch a segment, the substitution may occur.

Embodiments contemplate that a DASH MPD may supports one or both of:
A URL scheme based on a base URL and per-segments relative paths (the string substitution can be performed on the based URL in this case); and/or
A URL scheme where every segments has its own URL (the string substitution would be performed on all URLs in this case)

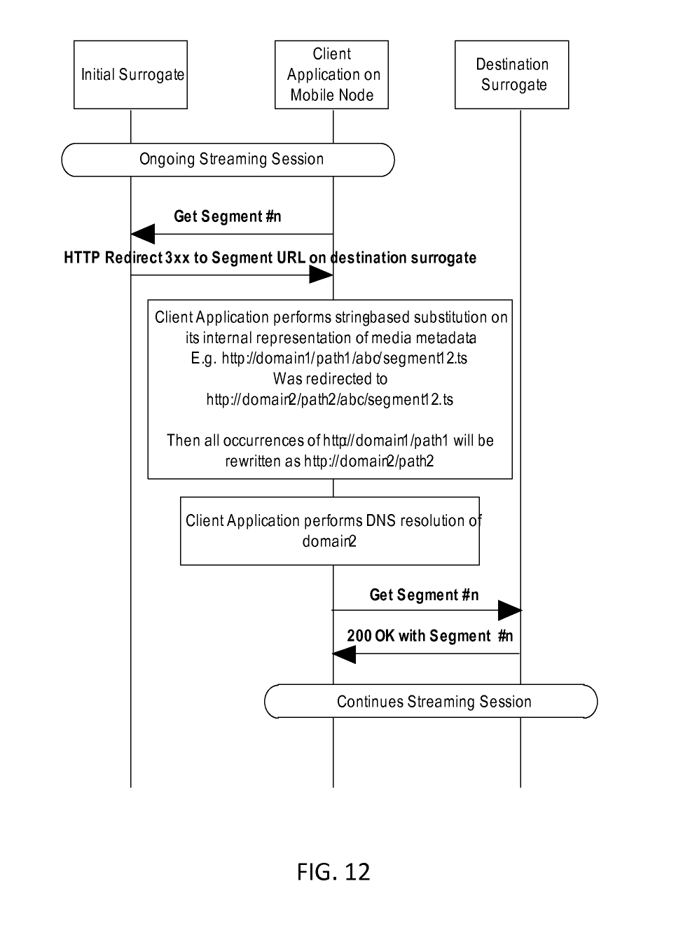

Embodiments also contemplate that the aforementioned embodiments may be useful for the Content on Demand use case where the media presentation description (MPD) may not need to be re-fetched, for example. FIG. 12 illustrates an example String substitution based redirection.

Embodiments contemplate Redirection of adaptive HTTP streaming session (which for purposes of explanation—and not limitation may be referred to as alternative 2, which may be implemented individually or in combination with other embodiments). In such an alternative, the redirection may also be implemented using a 3xx redirection message in response of a GET segment message, for example.

In one or more embodiments, the URL written in the redirection message may not be the URL of the segment on the destination surrogate. Instead, it may be the URL of the metadata (MPD) on the destination surrogate.

For instance, upon reception of the redirection message, among other potential reasons, the client application may perform one or more DNS resolution actions, and then may fetch the MPD, determine the next segment #n to fetch, and/or proceed with downloading segments starting with segment #n. One or more embodiments contemplate that #n may be generalization for the next segment to fetch in a continuous stream, for example perhaps where the last segment fetched before the redirection was #n−1, for example.

One or more embodiments contemplate redirecting the client application towards a MPD, and one or more embodiments contemplate the interpretation of this redirection by the client application, perhaps not as a normal URL redirection, but perhaps as a stream redirection.

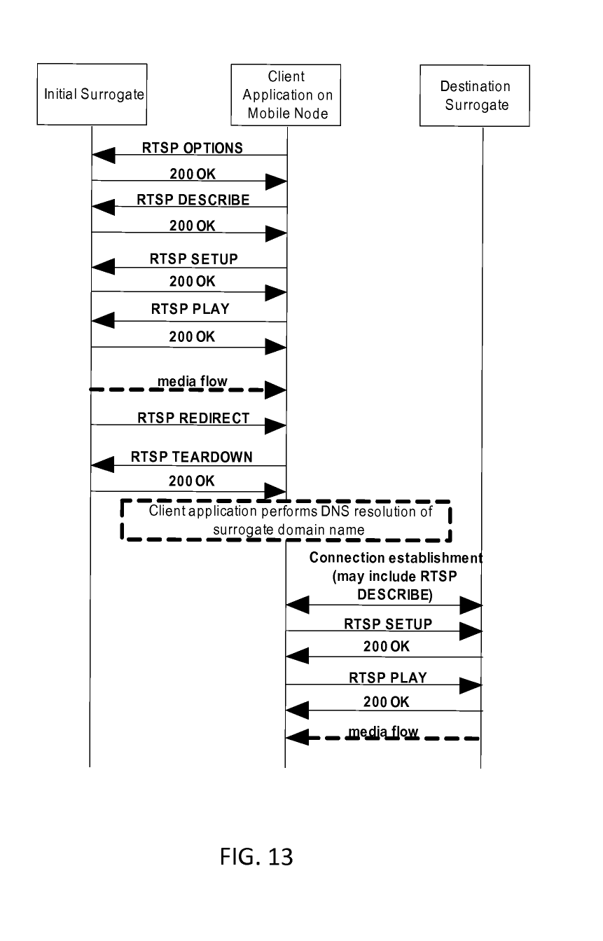

Embodiments contemplate Redirection of RTSP session. One or more of the embodiments described previously can apply to RTSP streaming. Embodiments contemplate that the mechanism used to redirect the client to the new/different surrogate may be the RTSP REDIRECT method. FIG. 13 describes how the existing RTSP redirect may provide the function contemplated by embodiments.

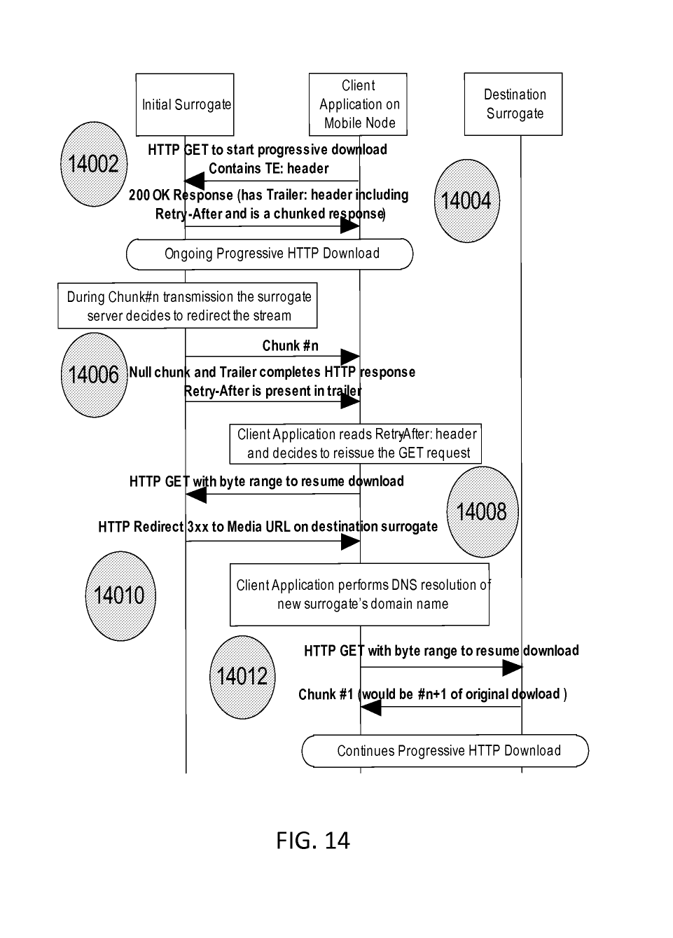

Embodiments contemplate Redirection of Progressive HTTP streaming. FIG. 14 illustrates at least one contemplated behavior for redirection using progressive HTTP streaming

Embodiments contemplate the heretofore unutilized usage of existing HTTP headers. At 14002, perhaps if the client application supports surrogate reselection, it may indicate support for trailers using for example the proper TE: header (TE: trailers). This header may indicate that the client may be willing to accept trailer headers at the end of the stream, for example.

At 14004, the surrogate server may indicate the possible presence of the Retry-After header in the trailer, perhaps by using the proper Trailer: header (Trailer: Retry-After).

At 14006, perhaps during the progressive download, the initial surrogate may decide to redirect the stream. The initial surrogate may complete the current chunk #n. It then may insert the final null chunk, followed with the trailer header Retry-After: 0. (Retry-After: in one or more embodiments—may not be inserted if the stream ended normally, for example).

Embodiments contemplate this usage of Retry-After, which may be used in 503 and 3xx responses.

As contemplated herein, Retry-After may be used as a trailer header in a chunked response. The following shows an example of HTTP response ending with the Retry-After header:

HTTP/1.1 200 OK

Transfer-Encoding: chunked

( . . . )

12000\r\n

(binary chunk)\r\n

0\r\n

Retry-After: 0\r\n

\r\n

At 14008, the client application may interpret a Retry-After: 0 and may retry (in some embodiments perhaps may immediately retry) downloading using a byte-range GET (for example, using a Range).

At 14010, the surrogate server may sends back a redirection message 3xx pointing to the media URL on the new/different surrogate. At 14012, the client application may resume downloading from the new/different surrogate.

One or more embodiments contemplate that one or both of the Trailer mechanism or the Retry-After may be existing elements of the HTTP standard. One or more embodiments contemplate the heretofore unutilized usage scenario. For example, embodiments recognize that Retry-After may not be used in 200 OK responses.

The contemplated embodiments may address backward compatibility with existing clients, for example, as follows: if an application client uses the header TE: trailers, then the surrogate server can deduce that the client may be likely to support redirection and may use the technique described previously. Since clients may use the TE: trailer perhaps without supporting the redirection method, then one or more embodiments contemplate additional heuristics can be used (e.g. User-Agent header).

Alternatively or additionally, one or more embodiments contemplate a solution that may include having the surrogate server close the TCP connection (at 14006) and the application client systematically trying to resume the download (at 14008).

One or more embodiments contemplate a CDN 1 as an authoritative CDN. Referring back to FIG. 11, if CDN 1 may be the authoritative CDN, then 11006 and 11010 may not be useful since the same CDN 1 may both detect the need for reselection and may perform the request routing 11008 ending in the selection of CDN 2 for content delivery.

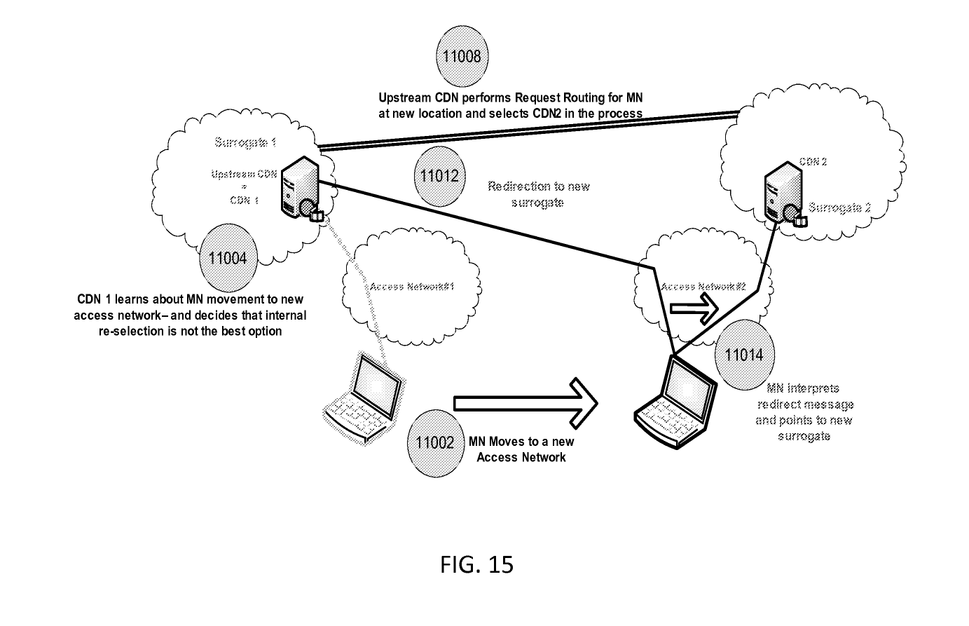

One or more embodiments contemplate that there may be no CDNI reselection message. CDN 1 may redirect the client using the redirection mechanism described previously, perhaps based on the result of its own request routing procedure. An example is illustrated in FIG. 15. The reference numbers in FIG. 15 refer to one or more of the reference numbers in FIG. 11 for purposes of simplified explanation with the differences noted in this and the previous paragraph.

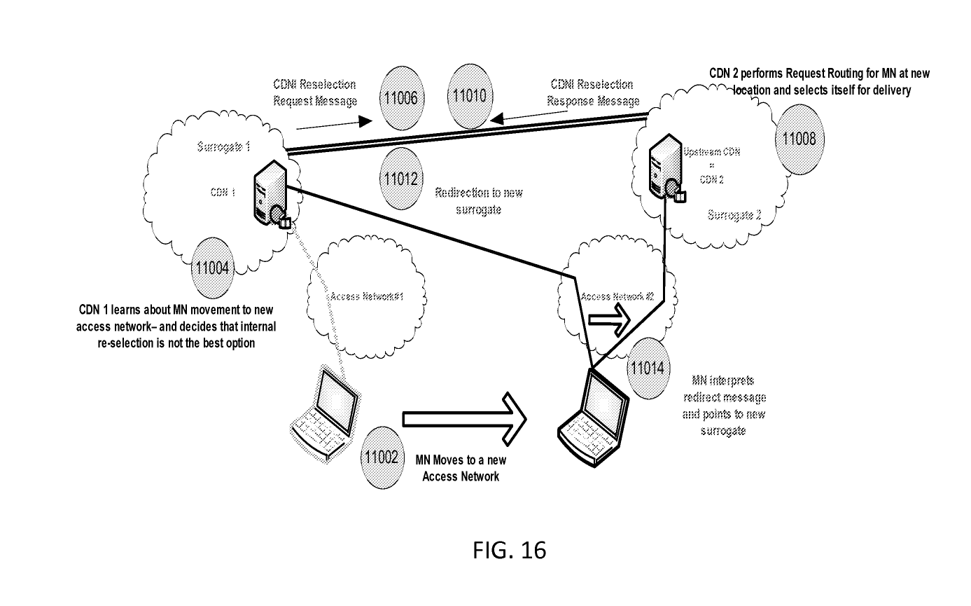

FIG. 16 illustrates an example of CDN 2 as the authoritative CDN, which may be viewed as a variant of the embodiment of FIG. 11. Referring back to FIG. 11, if CDN 2 is the authoritative CDN, then 11008 may be collapsed into an internal decision by CDN 2 to deliver the content itself. The reference numbers in FIG. 16 refer to one or more of the reference numbers in FIG. 11 for purposes of simplified explanation with the differences noted in this paragraph.

Embodiments contemplate Reselection Request Sent to Peer CDN. In such embodiments, CDN 1 may have a CDNI relationship with CDN 2. CDN 1 and CDN 2 may both cover complementary access networks. By way of example, and not limitation, CDN 1 may have a good coverage of DSL and WiFi users, while CDN 2 may have a good coverage of LTE users. One or more embodiments contemplate that CDN 1 and CDN 2 may have an agreement to transfer content delivery to each other.

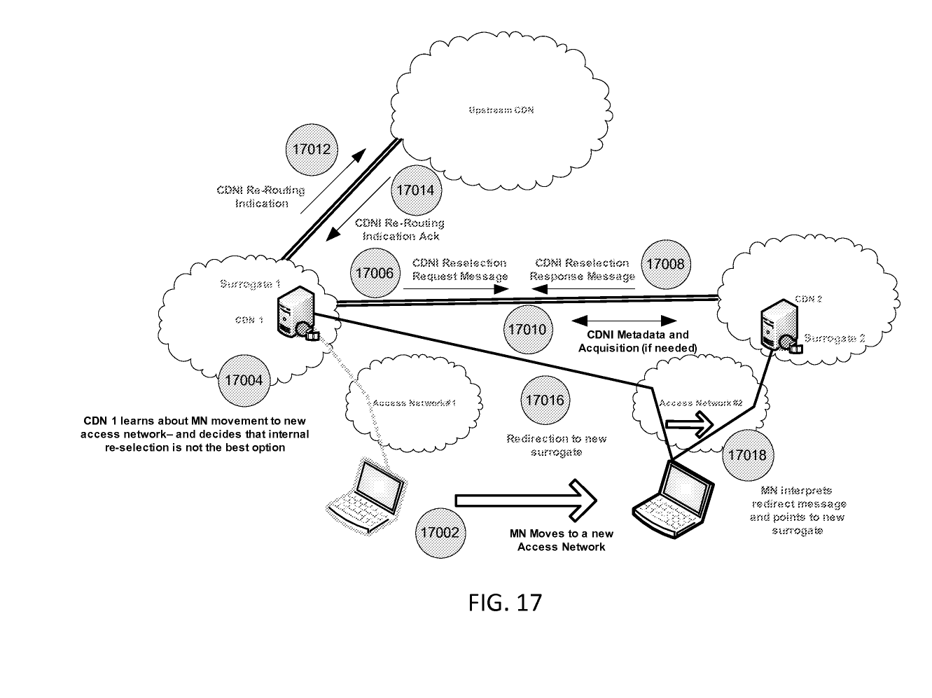

FIG. 17 describes an embodiment in which the authoritative CDN may be another upstream CDN (although embodiments contemplate that either CDN 1 or CDN 2 could also be the authoritative CDN for a given content, or that the authoritative CDN could be one or more layers above the upstream CDN, for example).

At 17002, 17004, a mobile node may move from one access network to another access network. CDN 1 may be aware of this and may decide not to continue delivering the content. One or more embodiments contemplate that CDN 1 may have a session transfer agreement with CDN 2. CDN 1 may decide that CDN 2 is a good candidate for resuming delivery, rather than referring back to the upstream CDN as contemplated in other embodiments. For example, CDN 1 may be configured with a block of end user IP addresses which may be well served by CDN 2. One or more embodiments contemplate that if CDN 1 does not decide that CDN 2 is a good candidate for delivery, it can fall back to a solution described in another embodiment.

At 17006, CDN 1 may send a CDNI Reselection Request Message.

At 17008, CDN 2 may send a CDNI Reselection Request Response to CDN 1. CDN 2 may refuse to deliver the content (e.g. it may not be able to fulfill the Quality of Experience (QoE) requirement because of a network overload). In such cases, embodiments contemplate that CDN 2 may use a negative status code.

At 17010, CDN 2 may obtain metadata and acquire content from CDN 1.

At 17012, 17014 alternatively or additionally, CDN 1 may inform the upstream CDN of the reselection, perhaps upon reception of CDN 2's response. Alternatively or additionally, CDN 2 may use CDN 1-CDN 2 CDN Interconnection messaging to report logging events to CDN 1, CDN 1 can continue to report back to the upstream CDN just as if it was delivering the content itself. Alternatively or additionally, CDN 1 may inform the upstream CDN as part of a business agreement (e.g. to show the frequency and effectiveness of res elections).

At 17016, 17018, embodiments contemplate that the initial surrogate server may send a redirection message to the application.

Embodiments contemplate CDNI Reselection Request and Response messages consistent with the previously disclosed embodiments. Embodiments contemplate that the messages may contain similar information as in previously described embodiments, with the following modifications and/or additions. Embodiments contemplate a Reselection Request that may contain information enabling CDN 2 to obtain metadata and content from CDN 1 (e.g. URLs of metadata and content to acquire).

Embodiments also contemplate a Reselection Response. One or more embodiments contemplate that a Response code may not hold some values mentioned previously with regard to other embodiments, perhaps because CDN 2 may not be authoritative and therefore may not take some decisions for CDN1. Embodiments contemplate that one or more responses may include: a Reselection Accepted (use attached URL for redirection, for example); and/or Reselection Rejected. For example, CDN 1 may choose to continue or stop delivering the content, or it may also choose to use one of the other embodiments described herein.

Embodiments contemplate CDNI Re-Routing Indication and Behavior. In one or more embodiments, either CDN 1 or CDN 2, or both CDNs, may report re-routing to the upstream CDN. This information may facilitate the upstream CDN to analyze reselection events.

Embodiments contemplate that the content of the messages may be include a Re-Routing Indication that may include one or more of: an Identifier of the content delivery session to reselect—this information can be used by the upstream CDN to match this re-routing indication with the history of this instance of content delivery; or some or all—or a subset of—the fields from the CDNI Reselection Requests and Responses can be included, perhaps in order to inform the upstream CDN of details of the operation (e.g. this can help demonstrating that reselection was performed before the Quality of Experience became unacceptable).

Embodiments contemplate that the content of the message may include a Re-Routing Response that may include a success code that can indicate if the data actually made sense to the upstream CDN (e.g. could it match with a content delivery).

One or more embodiments contemplate that CDN 1 may be the authoritative CDN (similar to that described for previous embodiments). Alternatively or additionally, one or more embodiments contemplate that CDN 2 may be the authoritative CDN (similar to that described for previous embodiments).

Embodiments contemplate Re-selection via client. In one or more embodiments, instead of requesting re-selection by an authoritative CDN, CDN 1 may trigger the client application to re-initiate a session using the origin server URL, and may resume streaming from where it stopped, for example.

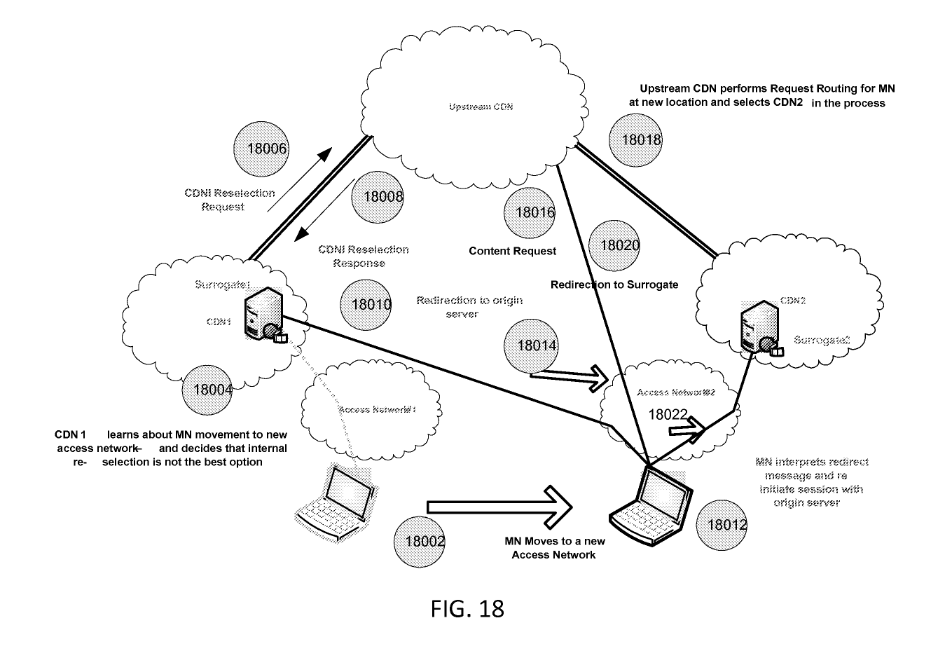

In one or more embodiments, the upstream CDN may not easily detect the transfer, and may match the two (2) sessions into one logical session. Embodiments contemplate that this issue may be attenuated by having CDN 1 send a message to the upstream CDN. This may help analyzing traffic trends, and may enable log analysis tools to match requests together. FIG. 18 illustrates an exemplary re-selection via client.

Referring to FIG. 18, at 18002, 18004, a mobile node may move from one access network to another access network. CDN 1 may be aware of this and may decide not to continue delivering the content.

At 18006, 18008 CDN 1 may send a CDNI Reselection Request Message. The upstream CDN may send back a response indicating that CDN 1 may redirect the mobile node to the origin server. In particular, the response message may contain the origin server URL of the content. These messages may be marked as alternatives and may be omitted if CDN 1 is configured to, perhaps always, redirect the mobile node to the origin server when needed.

Alternatively or additionally, in one or more embodiments, CDN 1 may be configured to always redirect to the origin server, and the CDNI reselection messages may still be used. In such embodiments, the CDNI reselection message may have a purely informative purpose (and thus have a content similar to the re-routing indication described previously).

At 18010, the initial surrogate may redirect the client back to the origin server.

At 18012, 18014, the MN (mobile node) may interpret the redirection. The detail of the redirection mechanism may vary, perhaps depending on the streaming protocol, but in some cases, or perhaps all cases, this may result in the client initiating connection with the origin server.

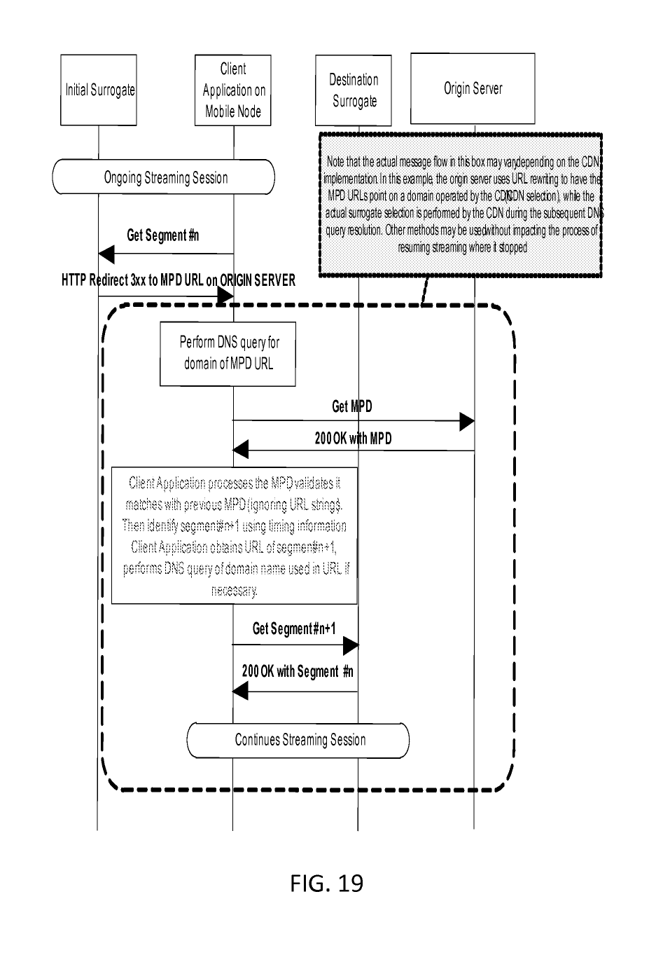

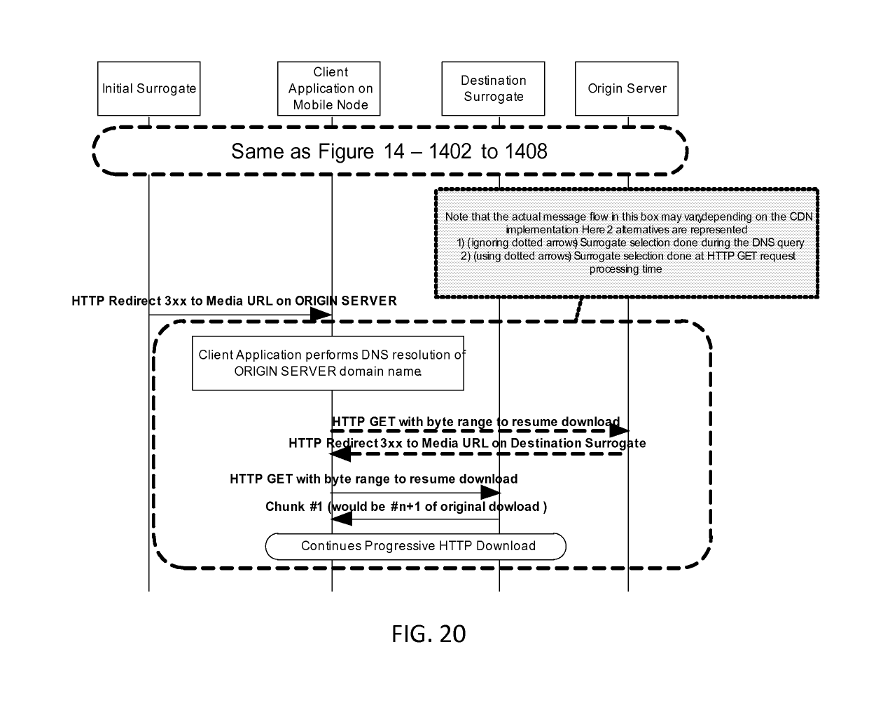

At 18016, 18018, 18020, and 18022, embodiments contemplate session establishment in presence of a CDN: content request, request routing, redirection, and streaming from a surrogate. In particular, one or more embodiments contemplate that the whole content request procedure may be run from the beginning, including the original DNS request. FIGS. 19 and 20 describe contemplated redirection techniques as applied to different exemplary streaming protocols.

Embodiments contemplate the Redirection of Adaptive HTTP Streaming Session. In one or more embodiments, the initial surrogate server may send a redirection message pointing to the URL of the MPD. In one or more embodiments, this URL may point to the URL of the MPD on the origin server (perhaps instead of the MPD on the new/different surrogate, for example).

Upon reception, the client may, and in some embodiments must, re-download the metadata from the given URL. In particular, the client may, and in some embodiments should, perform a new/fresh DNS request for the domain of the origin server (since some CDN implementations perform DNS-based redirection, among other reasons, for example). This may trigger a whole new/different request routing procedure, just like a new/different streaming session, for example.

Embodiments contemplate one or more of: redirection to the origin server MPD may be interpreted by the client as a stream redirection, and/or the client application procedure: may perform DNS request, may fetch metadata, may process the new/different metadata, and/or may match with old metadata to identify which segment to download next. FIG. 19 illustrates an example Redirection for Client Based Reselection with adaptive HTTP streaming (DASH).

Embodiments contemplate the Redirection of RTSP Session. This redirection may retain the same characteristics as the mechanism described previously, but one or more embodiments contemplate that the redirection target may now be located on the origin server. Subsequent DNS requests and/or resuming content download may trigger new/different CDN request routing and redirection.

Embodiments contemplate the Redirection of Progressive HTTP Streaming Session. Although similar to embodiments disclosed previously, one or more embodiments contemplate that the URL target of the redirection message may be the media URL on the origin server (instead of, for example, the media URL on the new/different surrogate).

Embodiments contemplate that when the client application may attempt to resume downloading from the target URL, the authoritative CDN may redirect the client as described herein (in one or more embodiments the actual CDN redirection method may depend on the CDN implementation). FIG. 20 illustrates an example Redirection for Client Based Reselection with Progressive HTTP Download.

Content Delivery Networks (CDNs) may host third party content for expedient and/or efficient delivery of static content, streaming media, and varying content services. In the particular case of streaming media, content request from a client node may result in the selection of a surrogate able to serve streaming content. Embodiments contemplate methods within CDNs to perform content redirection (also known as Request Routing) include using special DNS servers, application layer redirection, and content modification (URL rewriting), sometimes in combination. In addition, CDN Interconnection enables content redirection to cross CDN boundaries.

Embodiments recognize that mobile devices are more frequently used for streaming multimedia than in times previous. CDNs may optimize user experience and network traffic by selecting a surrogate streaming server close to the client node. Surrogate servers may be close to the edge of the Internet, may reduce latency, may better control QoS, and/or may limit traffic inside the network. In media streaming, the surrogate selection process may be transparent. The surrogate selection may occur at various points in time in the media streaming session establishment, perhaps depending on the request routing method used by the CDN (e.g. during the DNS request, or while fetching metadata). One or more embodiments contemplate that the surrogate may not be re-selected during the media session.

Using one or more of the above-described networks of FIGS. 1A-1E, and/or WiFi 802.11 networks, or other types of wireless or wired networks, the systems and methods described herein enable a Mobile Node (MN) to continue streaming from an optimal surrogate after moving to another access network. The newly/freshly selected or identified surrogate may be a different surrogate within the same CDN or a surrogate from another CDN. In one or more embodiments, the systems and methods enable continuity and optimized surrogate selection regardless of the CDN used, and regardless whether Mobile IP (MIP) is used or not. An example where MIP may not be used, is a device with 2 radios (e.g. cellular and WiFi), with a connection manager switching to WiFi when available, but perhaps without keeping a fixed IP address.

CDN networks may use DNS based request routing, and may assume that the DNS server used by the DNS client is “close” to the DNS client. Because different access networks (e.g. LTE and WiMAX) may be operated by different network operator with different CDNs, the applications using a given access network may use the “best” DNS server for this access network, which may be provided during IP Address acquisition on the access network using DHCP. Embodiments contemplate that the terms “network interface” and “network adapter” may be used interchangeably herein.

The systems and methods described herein may be used with multimedia streaming, which includes at least RTSP/RTP streaming, HTTP progressive download, and Adaptive HTTP Streaming. For example, the 3GPP transparent end-to-end Packet-switched Streaming Service (PSS) may support all three types of streaming protocols. The Real Time Streaming Protocol (RTSP) may be a network control protocol used with streaming media servers. It may be used to establish and control media sessions between end points. RTSP may be used along with Real-Time Transport Protocol (RTP) for media stream delivery. HTTP progressive download includes downloading a multimedia file, and starting to play the content when part of the file is downloaded. File download and playback may then be performed in parallel.

The contemplated adaptive HTTP Streaming solutions utilize a manifest file (e.g. an XML-based Media Presentation Description file in DASH), distinct from media file(s) (e.g., having a format extended from the ISO Base Media File Format). The media may be accessed by units (called segments in DASH and other standards); some or each segments may be obtained using the HTTP GET method (or a POST as the in the Akamai streaming solution).

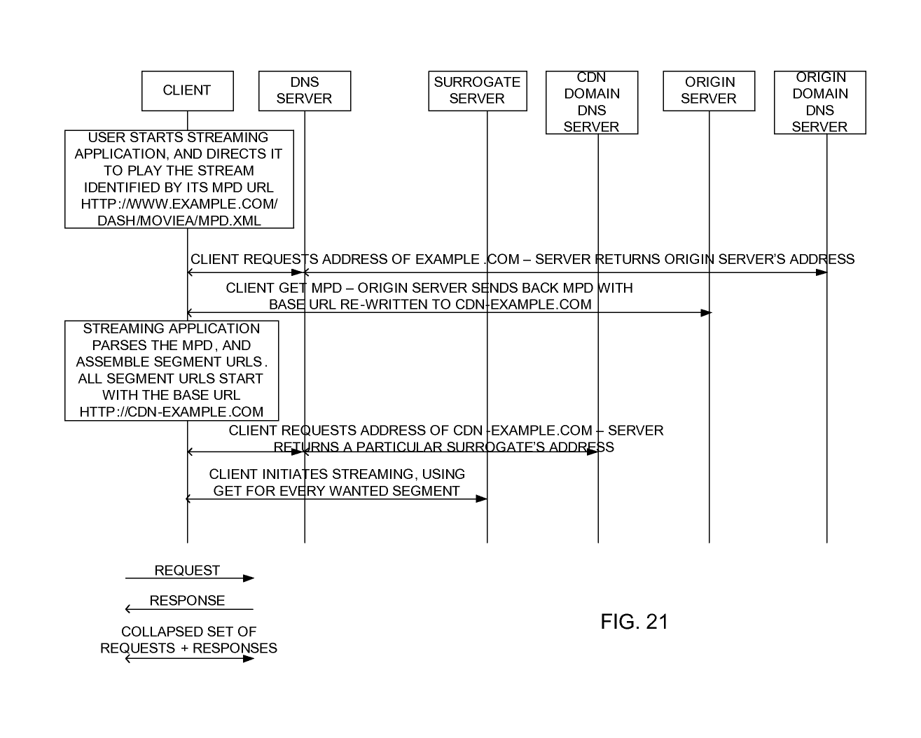

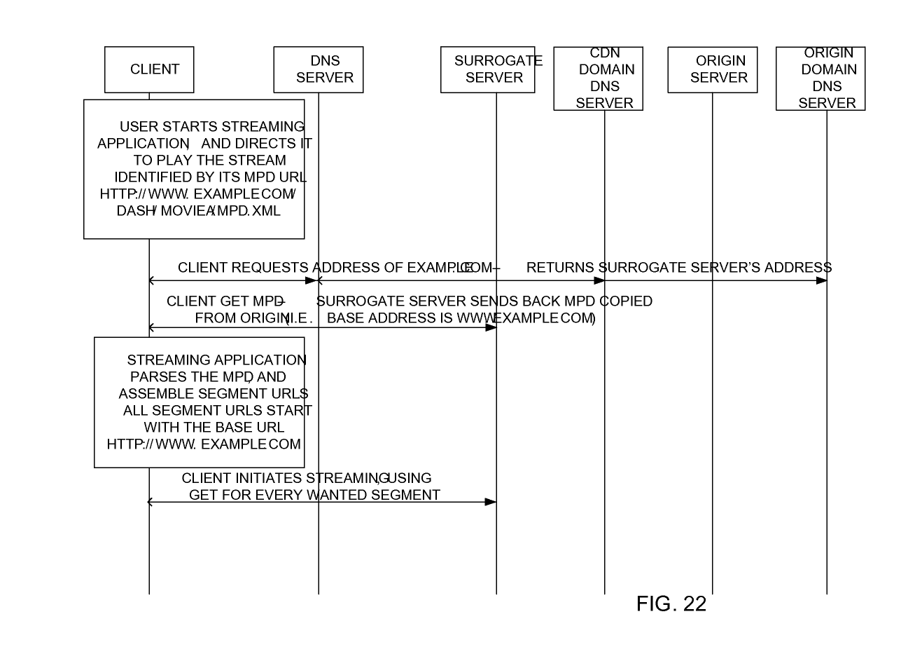

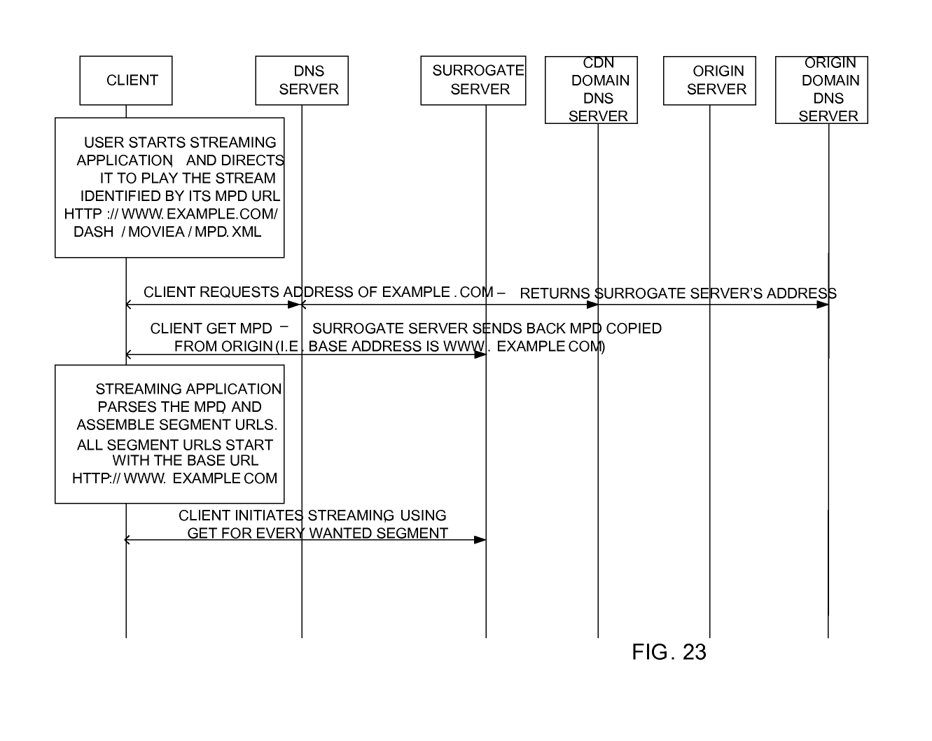

Embodiments contemplate various techniques of surrogate server selection/identification through DNS methods. As shown in FIG. 21, the origin server may dynamically rewrite URLs in the stream metadata, to point to an appropriate surrogate. One or more embodiments contemplate that additional DNS servers, such as root servers, may be involved in the DNS procedures, but are not depicted. That is, the origin server may be identified through a first DNS lookup, and the origin server may insert the CDN URL in the MPD. The client may perform a DNS of the CDN and may obtain the surrogate server address. As shown in FIG. 22, DNS redirection may be used. The initial DNS lookup of the origin server may return a CDN surrogate server address and the client may obtain the MPD file from the designated surrogate server with the origin URL (which may have already been resolved to the CDN surrogate server). As shown in FIG. 23, HTTP redirection may be used. After the address of the origin server is identified via DNS, the client may be redirected via http to the CDN network, and the CDN surrogate server may be identified via DNS. The MPD may then be provided by the CDN with the CDN URL, which in one or more embodiment may already be specific to the surrogate server.

FIGS. 21-23 are sample techniques of implementing CDN surrogate identification. Embodiments contemplate that other redirection mechanisms may be used. FIGS. 21-23 illustrate how some contemplated redirection methods may be used for DASH, but other streaming protocols can be redirected in a similar way. For example, two different CDNs may implement different redirection mechanisms.

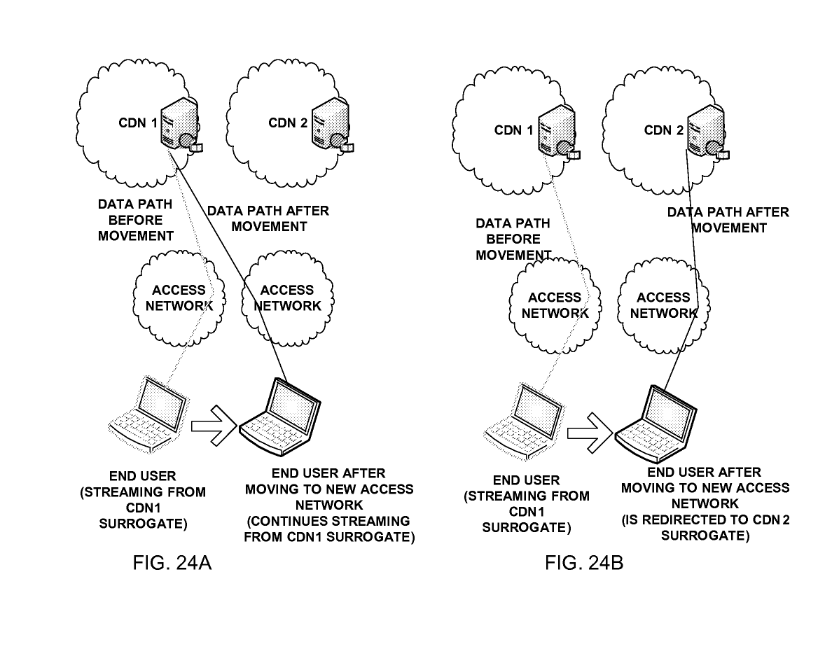

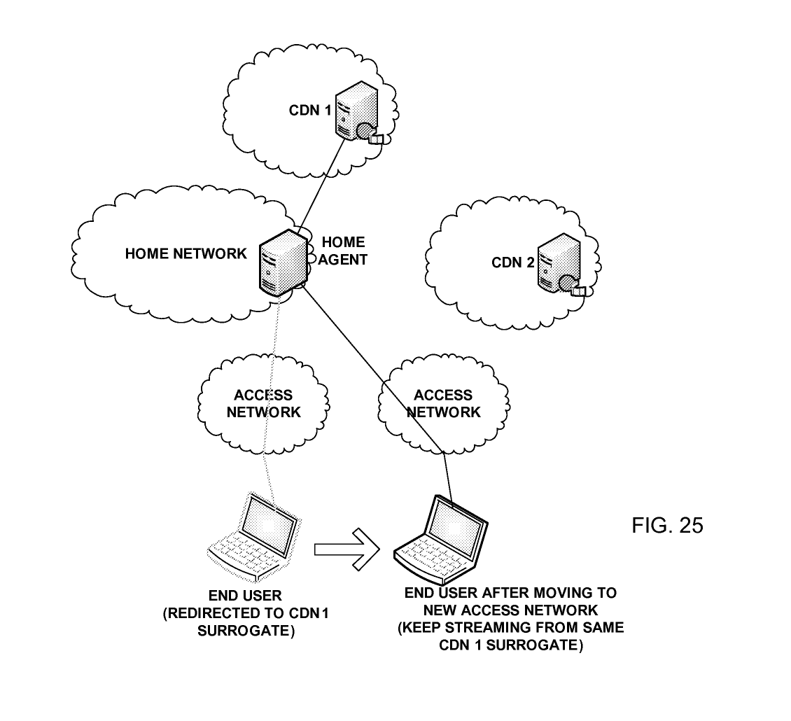

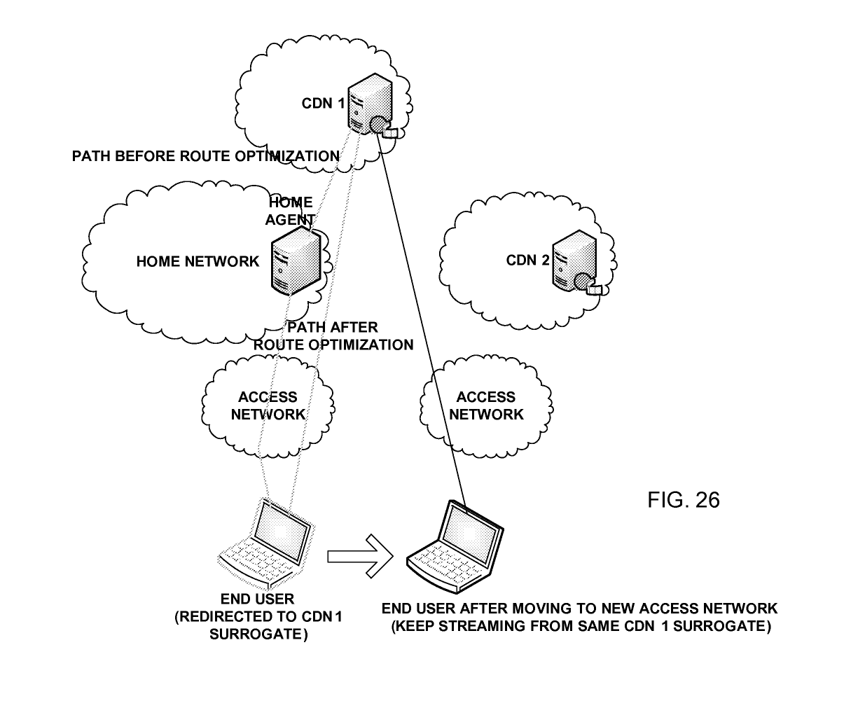

FIG. 24A depicts the scenario where CDN surrogate reselection may not be provided, while FIG. 24B shows the result of using contemplated embodiments described herein. FIGS. 25 and 26 depict similar deficiencies associated with scenarios when Mobile IP is used, demonstrating that the MN continues streaming from the initial CDN surrogate when the systems described herein are not utilized.

Specifically, with respect to FIG. 25, when MIP is used without optimization, if the mobile node is not on the home network, the IP traffic going to the device may go through the home agent, in the home network. This example conflicts with the optimization performed by CDN networks, since in this case, the selected CDN surrogate may be likely to be located close to the home network of the device, which is potentially far from the device. For example, CDN surrogate selection based on IP address-based location method or DNS will result in this kind of placement.

With respect to FIG. 26, specific techniques like routing optimization in MIPv6 may enable direct mobile node to server node communication, but the initial communication path between the mobile and the remote node may still pass through the home network (for the return routability procedure), and DNS-based request routing may not be impacted by this optimization. Hence, in some cases the CDN surrogate may be selected close to the home network again in this case (for example, DNS-based or HTTP redirection based on first packets source IP address). In other cases, the initial CDN surrogate may be properly selected close to the Mobile Node, but without surrogate re-selection after an MN movement.

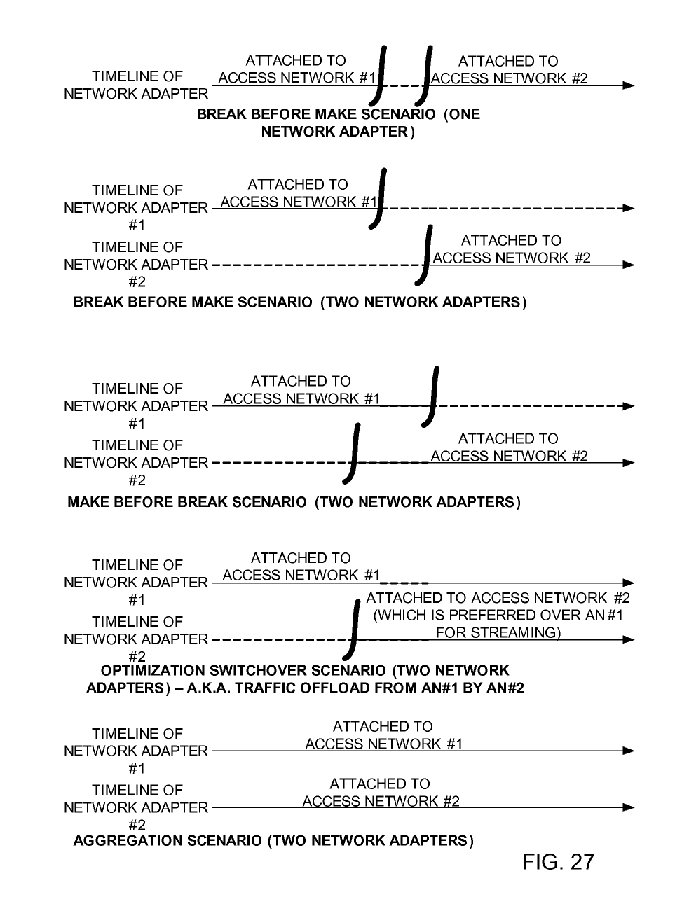

The diagram of FIG. 27 depicts various kinds of cases where either (i) continuity during an inter-access handover and/or (ii) stream aggregation across multiple access networks (while ensuring an optimized CDN surrogate selection) may be provided by various embodiments described herein.

As described herein, embodiments contemplate that the streaming session initiation phase refers to the first part of FIGS. 21-23, which includes DNS resolution and fetching metadata. Embodiments contemplate that additional operations may be performed in this streaming session initiation phase, such as authentication and Digital Rights Management (DRM) related communications, for example.

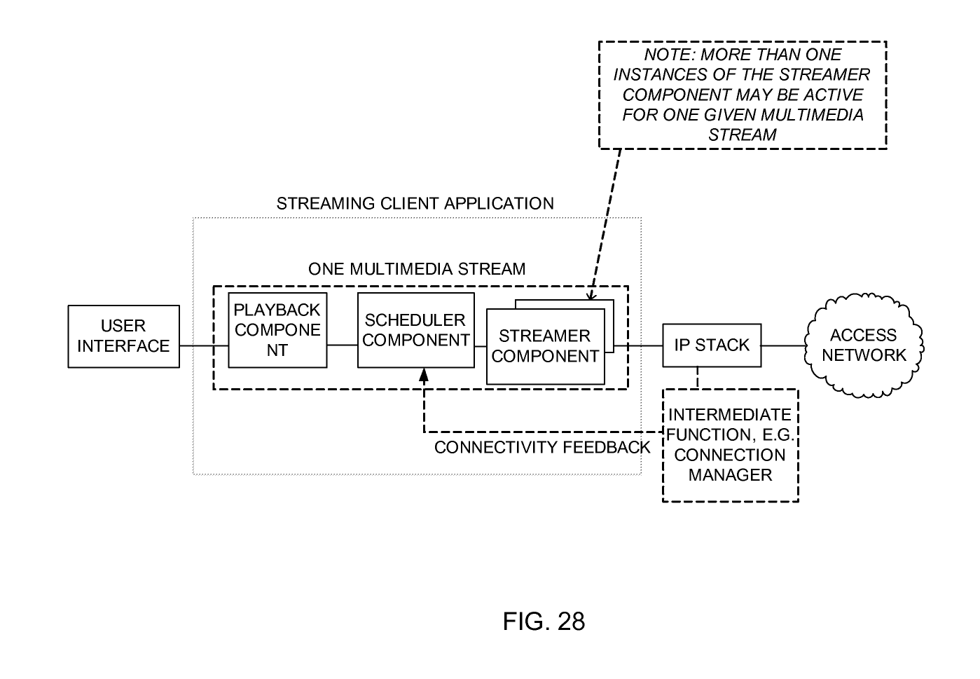

With respect to FIG. 28, a streaming client module architecture may be provided. It may be configured to follow a determined pattern at session initiation (e.g., for adaptive HTTP streaming, this may be a DNS request, followed by metadata fetching, and then segments download). Embodiments contemplate that different CDNs may use different techniques to select a surrogate and may redirect the streaming client to use this surrogate. The streaming client may be configured to again go through the client initiation phase when switching access networks, perhaps in such a way that any CDN may be able to properly redirect the client.

Target client applications include adaptive HTTP streaming, progressive HTTP streaming and RTSP/RTP/RTCP streaming application clients. Target Mobile Nodes include MIP-enabled hosts and regular IP (non-MIP) hosts. FIG. 28 depicts a contemplated decomposition of the streaming client application, which may be useful to further detail the client application behavior. The various modules described may be implemented in software and/or firmware stored in a computer readable medium and running on appropriate hardware components such as microprocessors, microcontrollers, application-specific integrated circuits (ASICs), etc., which when operating together, may be referred to collectively as one or more “modules”. Other combinations of the logical functions described herein may be provided in the form of other modules.

One or more embodiments contemplate an apparatus, the apparatus may comprises: a wireless network interface device having a communications protocol module configured to establish a network attachment to a wireless network; a streaming module configured to receive a content delivery network (CDN) surrogate server address and request portions of media content using the wireless network interface and the CDN surrogate server address; and a connection manager component configured to detect a network attachment notification associated with the wireless network interface device and to responsively initiate a CDN surrogate identification process. The connection manager may be configured to initiate a CDN surrogate identification process by requesting the streaming module to initiate a domain name service (DNS) request for a name associated with the portions of media content. Further, the apparatus may be configured such that the DNS request is invoked with a DNS server address parameter, and/or the DNS request is invoked with an indication to not use a DNS cache, and/or where the domain name service provides a local cache with entries having local/global indicator parameter.

The apparatus may further comprise a plurality of wireless network interface devices, each of the plurality of wireless network interface devices having at least one associated streamer module, and wherein each streamer module is configured to use a CDN surrogate server address associated with its respective network interface. Further, it may also comprise a scheduler module configured to allocate requests for portions of media content to the least one associated streamer module for each wireless network interface device.

In one or more embodiments, a stream module instance is a part of the client application configured to stream one single piece of content (by single piece of content—embodiments contemplate one multimedia presentations linked together through metadata); for example, a movie (audio+video+subtitle) provided by a single DASH Media Presentation Description (MPD). The playback module component may be configured to hold the playback buffer and render the content to the user, it can also be considered as a placeholder for other parts of the application which are not related to communication with the server. The scheduler module component may be configured to determine which instance of the streamer module component should be allocated the task of downloading which segment. There may be one streamer module instance per access network currently in use (e.g., one in single network adapter use cases with hard handover, or two during a soft handover, or n (>=2) in the aggregation use case. The scheduler module may use information about the network attachments, which is marked as connectivity feedback in FIG. 28, and may be obtained through an intermediary like a connection manager module for example. The scheduler module may be configured to use this information to determine whether to create a streamer module instance attached to a particular adapter (and IP address), and also be configured to use this information to determine which streamer to use to retrieve a particular segment.

The architecture (logical function decomposition) described previously may be used to represent current media players using a single streamer instance. Some embodiments described herein introduce multiple streamer modules instances and scheduler modules, which may perform some or all of the following functions. A streamer instance may be configured to download metadata, and media segments as determined by the scheduler module. A streamer may be configured to use the local IP address of its network adapter as the source address for all IP traffic (even if MIP may be used on this host for other traffic). Moreover, a streamer module may be configured to initiate DNS requests using the DNS server(s) most relevant to this interface (e.g. obtained through DHCP from the attached access network). In particular, embodiments contemplate that a streamer may perform DNS requests (for the media server domain name) and may fetch metadata before downloading some segments or any segment. In some embodiments, this may enable various CDN request routing mechanisms to properly function.

Embodiments contemplate that a scheduler component may be configured to determine which network adapter(s) to use, when to start streamer module instances as needed, to obtain information about network attachments (e.g., connectivity feedback arrow in FIG. 28), take handover decisions, and/or in the aggregation case of selecting which streamer to use to fetch a particular segment (an example of aggregation algorithm described herein). The scheduler module may be configured to use metadata, local policy and possibly user input to take decisions. It may also be configured to compare and validate metadata obtained through different streamer modules.

Embodiments contemplate that during a handover, the scheduler can obtain partial data from the original streamer (for example, this may be a part of the last media segment fetched), and may request a partial download from the next streamer (e.g. using byte range HTTP GET for this media segment in DASH).

Streaming sessions may have playback buffers of at least a few seconds. This can enable maintaining session continuity even over a hard handover. Because one major CDN redirection method is DNS based, a per-interface DNS selection mechanism may ensure that the client application can select which DNS will be used for every request. In one or more embodiments, the API defined by MIF-API may be used for this purpose. Embodiments contemplate that one or more additional constraints on local DNS caching may be added to adapt to DNS-based location practices.

One or more embodiments contemplate that aggregation may require some sort of content segmentation, which may be built-in Adaptive HTTP Streaming, but can be obtained as well in a different form in Progressive HTTP Streaming and RTSP/RTP/RTCP based streaming Relatively simple handover cases may require being able to resume a session from where it stopped, which can also be handled by all three forms of considered streaming technologies contemplated herein.

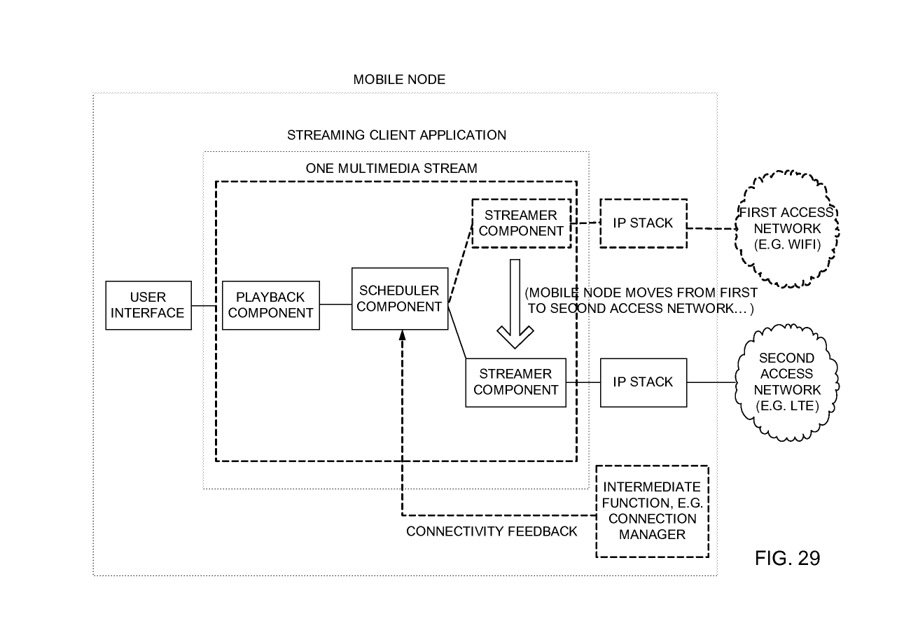

In one or more embodiments of Adaptive HTTP Streaming handover and aggregation, the first four cases of FIG. 27 may be addressed (e.g., session continuity with hard handover using one network adapter, two network adapters, soft handover and optimization handover using two network adapters). The diagram of FIG. 29 illustrates exemplary a high level streaming client application architecture enabling session continuity. In this diagram, the upper streamer module is the initial streamer module instance. Upon handover, among other reasons, another streamer module instance may be created to continue streaming (for example using another access network, and using the same or a different adapter depending on the use case).

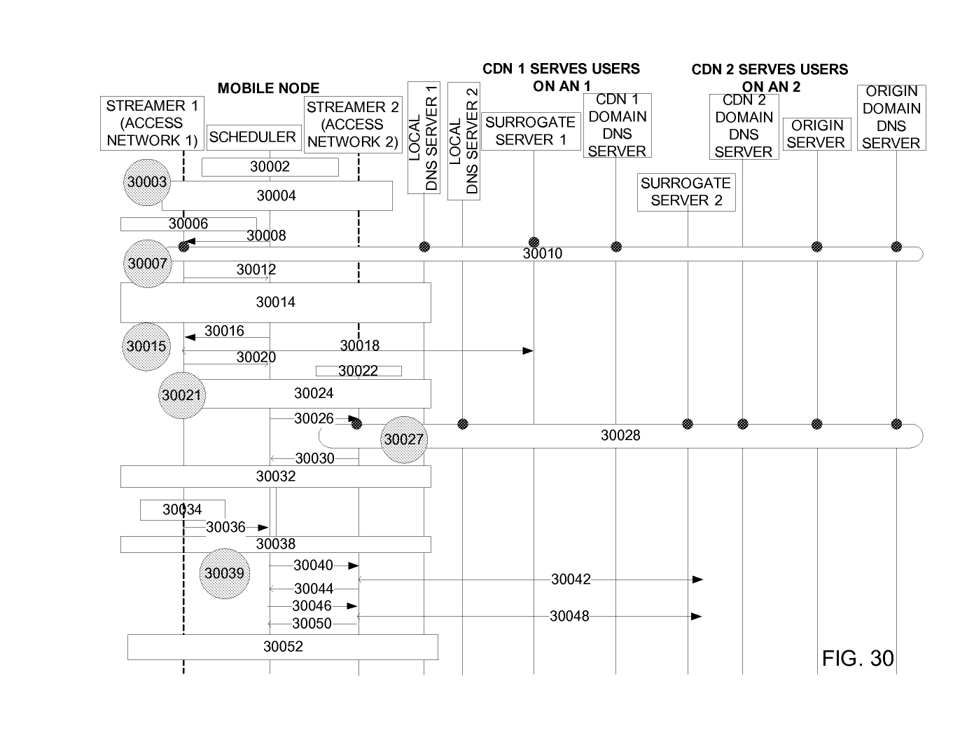

The flow diagram of FIG. 30 illustrates how service continuity occurs across access networks, with the given architecture. At communication 30002, the client device (e.g., WTRU 102) may start a streaming application, which may be a result of input provided by a user. A scheduler module instance may be created. At communication 30004, the scheduler module may check network adapters/network devices. Initially, in this depiction, one is attached (#1). The scheduler module may create streamer module instance #1 with the parameters: network adapter, IP address to use, URL to fetch metadata. At communication 30006 streamer #1 module instance may start. At communication 30008 there may be a Session Init Request. At communication 30010, streaming session initiation may be performed, including DNS resolution and fetching metadata (in some embodiments the marked nodes may or may not participate, depending on CDN redirection method). At communication 30012 Streamer #1 module may provide metadata to the scheduler module. At communication 30014 the scheduler module may, and in some embodiments perhaps continuously, request segments from streamer #1 module, filling then maintaining filled the playback module's buffer, and using HTTP adaptation as needed, the scheduler module may check network adapters (either synchronous poll or asynchronous indication may be used, for example). At communication 30016, a Segment Request may be sent. At communication 30018, the client streamer module component may fetch segment from surrogate server 1. At communication 30020, streamer #1 module may provide media segment to the scheduler module. At communication 30022, the MN may be attached to access network AN2.

At communication 30024, the network attachment may be detected by the scheduler module. The scheduler modules may start a new/different streamer module instance to prepare for possible handover (or, in case AN2 is preferred, to switch over to using AN2, perhaps immediately). At communication 30026, a Session Init Request may be sent. At communication 30028, the streaming session may be initiated, including DNS resolution and fetching metadata (in some embodiments, the marked nodes may or may not participate, depending on CDN redirection method). At communication 30030 streamer #2 module may provide metadata to the scheduler module. At communication 30032, perhaps based on local policy (and possibly user input) the scheduler module may select a streamer module to use. In this example as depicted, it stays on streamer #1 module. At communication 30034, the MN may lose attachment to AN1. At communication 30036 Streamer #1 module may provide the last partial media segment n to the scheduler module. At communication 30038, the scheduler module may detect the loss of attachment and may switch over to streamer #2 module. The scheduler module may terminate streamer #1 module instance. At communication 30040 a Partial Segment Request n may be sent. At communication 30042, the client streamer module component may fetch partial segment from surrogate server 2 (e.g. using byte range). At communication 30044, streamer #1 module may provide a partial media segment to the scheduler module. At communication 30046, a Segment Request n+1 may be made. At communication 30048, the client streamer module component may fetch a segment from surrogate server 2. At communication 30050, streamer #1 module may provide a media segment to the scheduler module. At communication 30052, the scheduler module may, perhaps continuously, request segments from streamer #2 module, maintaining a filled playback buffer, and using HTTP adaptation as needed, the scheduler module may check network adapters.

Generally, the contemplated sequence describes a soft handover scenario. The following notes refer to the diagram of FIG. 30: Pre-requisites: the Mobile Node may keep some or all DNS server information obtained from all access networks attachments. When the MN attaches to an access network, it may obtain primary and secondary DNS servers from a DHCP server on the link (as well as its local IP address). In some embodiments, the DNS servers (e.g., DNS server addresses) received over each currently attached access networks may be maintained by the Mobile Node. In particular, the scheduler may be able to direct or control certain aspects of the DNS request, such as direct a DNS request to use the DNS server(s) related to one particular access network.

In FIG. 30, the circle 30003 indicates that the scheduler module may select a network adapter (in case of conflict, it may use a local policy to decide). Then, the scheduler module may select which IP address to use. For example, the first (and in some embodiments perhaps only) IP address attached to this adapter may be used. At circle 30007 and circle 30027, a Session Initiation Phase is depicted. The streamer module may perform DNS requests and may fetches metadata. The resulting message flow may for example follow any of FIGS. 21-23, and may depend on the request routing method used by the CDN. In particular, the socket API extension proposed in MIF-API may be used: struct hostent *gethostbyname(const char *name, struct sockaddr *DNS_addr), where name is the host name to resolve (as per the existing gethostbyname function), and where the new/different parameter DNS_addr is the DNS server to use for the resolution. One or more embodiments contemplate that the actual call to this API may be performed by another system component, such as a connection manager, while the streamer may retain the ability to trigger a name resolution for a given network adapter (or source IP address).

Embodiments contemplate that the client DNS caching may be handled in the following manner by some embodiments: a DNS response obtained by a streamer module instance (using a given DNS server) and present in cache may not be used to fulfill a DNS request by another streamer module (using another DNS server). In one or more embodiments, the DNS client cache implementation may associate the DNS Server IP address with a cached name record. One or more embodiments contemplate that in order to get a cache hit, the DNS Server IP address may match.

Embodiments recognize that the local DNS cache may contain a record name (the name that may gave been used in the DNS query, such as “www.example.com”), the record type (e.g., 1 for a “A” records, 28 for a “AAAA” records), and the record value (e.g., an IPv4 address for an “A” record, an IPv6 address for an “AAAA” record, etc.). For example, the Windows XP command ipconfig/displaydns list this information.

Embodiments contemplate that when a DNS query is made, the DNS client may check for matching record name and type. If a match is found, no query may be sent to the DNS server and the cached value may be returned to the querying application. In one or more embodiments, the DNS client cache may include an additional field, which may be the IP address of the DNS server used for the query. If the DNS IP address is provided by the application that made the query (using the modified gethostbyname function, or similar function for example), then the DNS IP address may be used (perhaps along with the currently used fields including record name and type) to compute the cache hit.

If the DNS IP address is not provided by the application (e.g., using a variant of gethostbyname similar to the original function, or setting the DNS IP address to NULL in the modified gethostbyname function), then the DNS IP address may not be used to compute the cache hit. This distinction may be useful to optimize the DNS client cache efficiency in the general case where the application may not care which interface may be used, and where the DNS response may be the same regardless of the DNS server used.

Alternatively or additionally, one or more embodiments contemplate that the socket API may be modified to include “bypass cache” bits as follows: struct hostent *gethostbyname(const char *name, struct sockaddr *DNS_addr, int flag)/* if bit #0 of flag is set, the operation may not check the local cache, if bit #1 of flag is set, the operation may not result in any local cache update */.

Embodiments contemplate that one or more of these flags may be set by applications that may find a per-access network behavior to be useful, such as the multimedia application described herein, and in some embodiments may only be set by such applications.

Perhaps as a result of the session initiation phase, the fetched metadata may be handed over to the scheduler. The scheduler can check metadata consistency across access networks (e.g. base URLs may be different, but the segmentation may be the same). Consistency may be useful, for example, for correct identification of the first segment to request from streamer #2 in circle 30039.

At circle 30015, during streaming, the client application may monitor (possibly using the service of a connection manager) some or all network adapters to detect their attachment status.

At circle 30021, perhaps when a new/different attachment is detected, the scheduler module may start the streaming process on the new/different access network, and then may either (a) move the streaming session to the new/different access network, or (b) may wait until the first streamer module instance fails, and then may use the new/different one. In FIG. 30, the case (b) “soft handover” is shown at circle 30039. Case (a) can be described as an “optimization handover”.

At circle 30039, an HTTP byte range GET can be used to obtain the remaining part from the last segment partially obtained from streamer #1 module. If a partial retrieval is not possible (e.g. using POST instead of GET, or byte range not supported), then streamer #2 module may retrieve the whole segment.

One or more embodiments contemplate that CDN surrogate servers 1 and 2 may belong to different CDNs. In embodiments, surrogate servers 1 and 2 could also belong to the same CDN. Embodiments also contemplate that other handover scenarios (e.g., see FIG. 27) may be supported as well. Some examples are listed here, with indication of differences from FIG. 30: (i) Hard handover, two network adapters: MN may lose attachment to Access Network #1 before attaching to Access Network #2. Playback may continue anyway (perhaps as long as the playback buffer is not empty, for example). The Scheduler module may terminate the streamer module instance and may continue monitoring the network adapters. As long as a new/different attachment is detected, among other reasons, the scheduler module may start a new/different streamer module instance; (ii) Hard handover, one network adapter: similar to the two adapters' case describe previously, except that the scheduler module may have one network adapter to monitor; and/or (iii) Optimization handover: which may be similar to FIG. 30, except that the scheduler module may decide to use streamer #2 module as soon as streamer #2 module's initiation procedure may be completed. In one or more embodiments, this decision can be based on a local policy (e.g. WiFi preferred over LTE).

With respect to FIG. 30, in an exemplary embodiment, a method may comprise: receiving content at a mobile node from a first surrogate server of a content delivery network (CDN); receiving a network attachment notification associated with the mobile node's network attachment; responsively initiating a CDN surrogate selection to identify a second surrogate server; and, receiving content at the mobile node from the second surrogate server. The first surrogate server may be identified using a domain name service. In addition, the network attachment notification may be a network attachment event generated by a protocol stack of the mobile node, or it may be a handoff indication, or a detection of a second network attachment. Furthermore, the first surrogate server and the second surrogate server may be identified using domain name service (DNS). In some embodiments, the domain name service may be invoked with a DNS server associated with a specific network attachment, or it may be invoked with a DNS server address parameter. The domain name service may be invoked with an indication to not use a DNS cache, and/or the domain name service may provide a local cache with entries having local/global indicator parameter.

As an extension of the embodiments described above, one or more embodiments contemplate the client application module may implement streaming aggregation by having the scheduler module retrieve segments from two or more streamer module instances concurrently. Some or perhaps every streamer module instance may connect to a potentially different CDN surrogate server through a different access network.

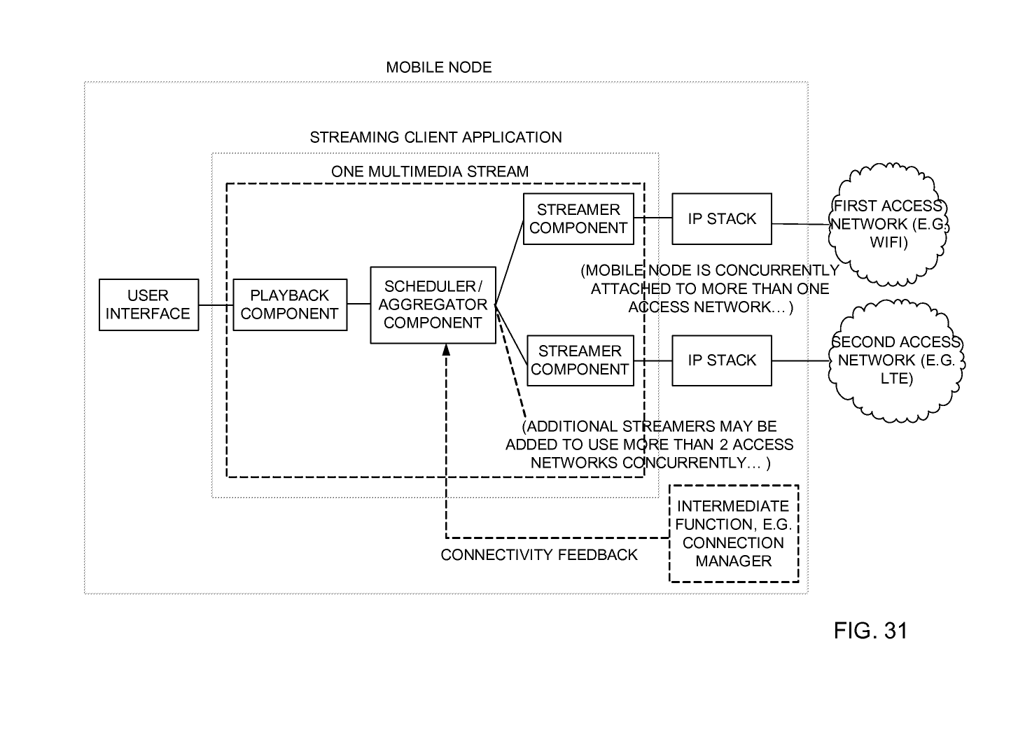

The diagram of FIG. 31 describes an exemplary apparatus module architecture for stream aggregation. One or more embodiments contemplate that the stream aggregation role performed by the scheduler module may control two or more streamer components simultaneously.

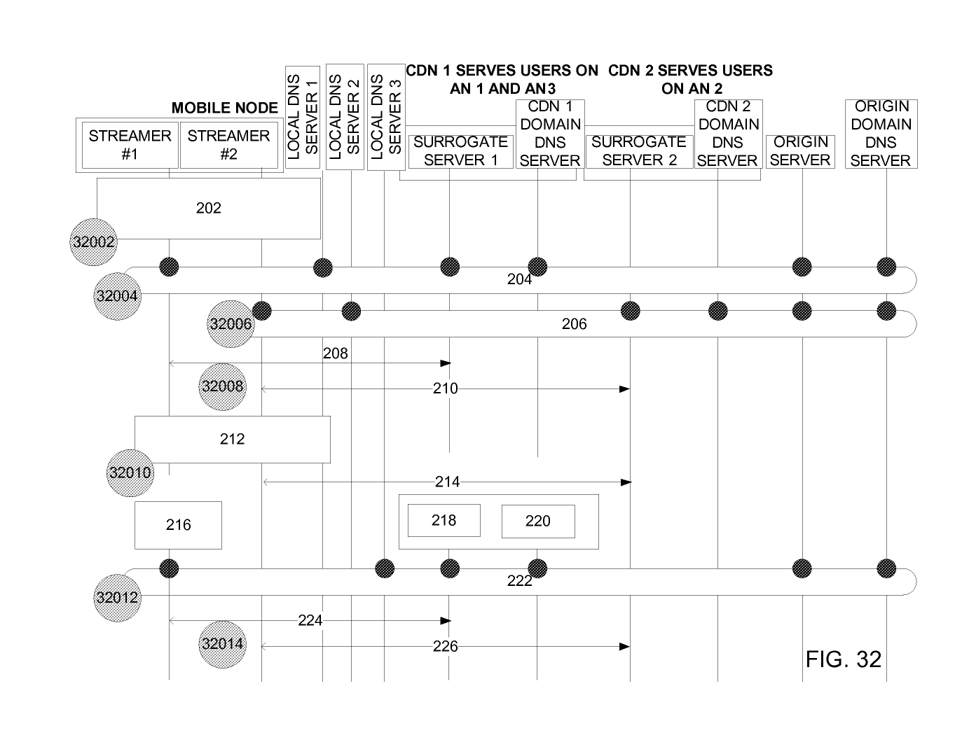

The diagram of FIG. 32 illustrates how one or more embodiments contemplate that a mobile node concurrently attached to two access networks may stream using application level aggregation. An example of a mobility event (which may be one type of network attachment notification) is also shown as a mobile node losing access to one access network, then reattaching to another access network.

At communication 202 the client may start a streaming application module. The Mobile node may be attached on access network 1 and 2. Two streamer module instances may be used (using local IP addresses obtained from AN 1 and AN 2 for example). At communication 204, a streaming session may be initiated (in some embodiments, marked nodes may or may not participate, depending on CDN redirection method). At communication 206, a streaming session may be initiated (in some embodiments, marked nodes may or may not participate, depending on CDN redirection method). At communication 208, client streamer module component may fetch segments from surrogate server 1. At communication 210 client streamer module component may fetch segments from surrogate server 2. At communication 212, the MN may lose attachment to AN1. The application may continue streaming using Access Network 2 (AN 2) streamer. At communication 214, client streamer module component may fetch segments from surrogate server 2. At communication 216, attachment to another Access Network may be detected. Note that surrogate Server 3 is depicted as 218 and CDN 3 Domain DNS Server is depicted as 220. At communication 222, Streaming session may be initiated (in some embodiments, marked nodes may or may not participate, depending on CDN redirection method). At communication 224 client streamer module component may fetch segments from surrogate server 3. At communication 226, client streamer module component may fetch segments from surrogate server 2.

In one or more embodiments, the client application may behave as follows: At circle-32002, assuming the client application module is configured to use aggregation the scheduler may create several streamer module instances at start up, and may request some or all of them to perform session initiation. At circle-32004, circle-32006, and circle-32012, these session initiation steps are substantially similar to session initiation described with respect to FIG. 30. At the end, each streamer module instance may provide the obtained metadata to the scheduler. At circle-32008, the scheduler may distribute segment requests between some or all available streamer modules.

At circle-32010, an exemplary mobility event is contemplated. Perhaps when an access network attachment is lost, the scheduler module may fall back to using the remaining streamer modules. One or more embodiments contemplate that other use cases mixing aggregation and mobility events may occur. For example, a stream may start over a (single) LTE access network, and then the device may be attached over a WiFi access network. Streams over these two access networks may be aggregated from this point on. Later on, the scheduler module may determine to stream entirely over WiFi and keep the LTE streamer module unused but ready in case the WiFi link is lost. At circle-32014, the state of the client may be set back to a normal aggregation state, after connectivity may be restored on the first access network.

Although embodiments contemplate that many different scheduling may be used, two exemplary families of aggregation algorithms are described here. “Throughput” may focus on maximizing throughput, and “Cost” may focus on using the lower cost access network and use others when useful, or perhaps in some embodiments needed, to maintain the service.

Embodiments contemplate that initial playback buffer filling methods may depend on local policy. For “Throughput” embodiments may request segments on some or all available access networks. For “Cost”, embodiments may request segments on the lowest cost link available, perhaps as determined by local policy (e.g. choose WiFi over LTE). Embodiments contemplate a fall back to other access networks if the throughput may be insufficient.

In one or more contemplated exemplary steady state periods, the scheduler may perform the following: For “Throughput” embodiments may request segments to maintain the playback buffer filled, combining available bandwidth on some or all access networks. For “Cost”, embodiments may request segment from the least expensive link, adapting the bit rate (e.g., choosing a new/different representation) when useful, or in some embodiments when necessary, to keep using this single streamer.

In case of a mobility event, like the loss of attachment on an access network, the scheduler may use the remaining streamer instances to continue operating.

One or more embodiments contemplate that the session continuity and aggregation methods and systems described herein may provide CDN surrogate selection and re-selection and session continuity for nomadic nodes and client-based MIP nodes (e.g. a client application using this invention may use a Care-of-Address instead of Home Address). In one or more embodiments, it may not interfere with usage of Proxy Mobile IP (PMIP). For example, in at least one instance, the IP stack/connectivity manager may be able to detect and report mobility events to the client application, where this embodiment can be used. In another instance, the IP stack/connectivity manager may not be able to detect and report mobility events and the client application implementing one or more embodiments may not perform any session continuity procedure and therefore may not interfere with any network-side surrogate optimization that could take place. Embodiments contemplate nomadic nodes, for example a laptop not using MIP or PMIP, —such as when the laptop may be disconnected, then may re-attach to another network shortly after, then the client application can resume streaming If the re-attachment happens while the playback buffer does still contain media, one or more embodiments contemplate that it may be possible to maintain session continuity.

One or embodiments may comprise establishing a plurality of network attachments to a plurality of networks over a corresponding plurality of network interfaces of a mobile node; for each of the plurality of network interfaces, initiating a CDN surrogate identification process and receiving corresponding CDN surrogate server addresses; requesting a plurality of portions of content via the plurality of network interfaces using the corresponding CDN surrogate server addresses; and, receiving and aggregating the plurality of portions of content. The method may further comprise: receiving a network attachment notification associated with at least one of the plurality of the mobile node's network attachments; and responsively initiating a CDN surrogate selection.

One or more embodiments contemplate progressive HTTP download handover and aggregation. Embodiments contemplate that progressive download may be supported in a manner similar to the HTTP adaptive streaming described previously. In one or more embodiments, the following differences may apply to the previously described embodiments. There may be no associated metadata associated with progressive HTTP download. This may impact the initial phase of some or every streamer module, which may be reduced to resolving the media server name using DNS. There may be no segmentation of the file being downloaded. Media that may be transferred using a single HTTP may get served using HTTP chunking by the server (in particular, note that this may mean that a single TCP session may be used for this transfer). The streamer module may transfer data up to the scheduler module once per received chunk. After a mobility event, the scheduler module may request the new/different streamer module to download the remaining part of the file using a byte range download (e.g. use HTTP header “Range: bytes=500-” to get some or all remaining bytes after the first 500 bytes of the file).

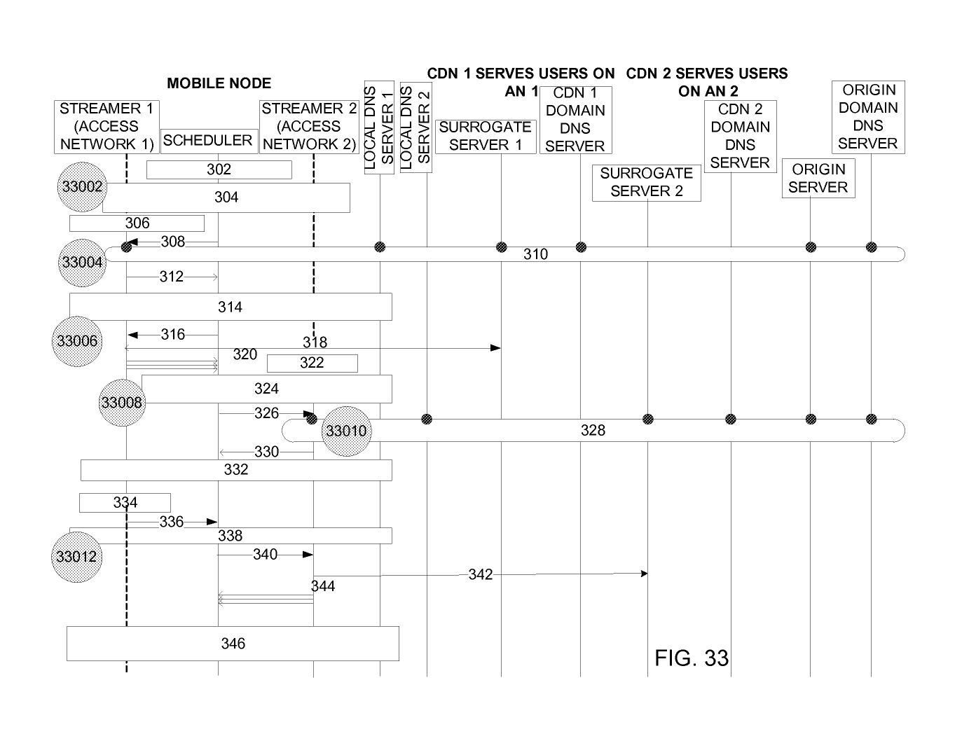

The diagram of FIG. 33 describes an exemplary session continuity scenario with Progress HTTP Download. At communication 302 the client device Mobile Node (e.g. WTRU) may invokes a streaming application. A scheduler module instance may be created. At communication 304, the scheduler module may check network adapters. One may be attached (#1). The scheduler module may create streamer module instance #1 with the parameters: network adapter, IP address to use, URL to fetch metadata. At communication 306 streamer #1 module instance may start. At communication 308 a Session Init Request may be sent. At communication 310 a streaming session may be initiated, which may be DNS resolution (in one or more embodiments, marked nodes may or may not participate, depending on CDN redirection method). At communication 312 streamer #1 module may indicate it may be ready to download. At communication 314, scheduler module may start downloading, and may be ready to receive data from streamer module. The scheduler module may check network adapters (in some embodiments, both synchronous poll and asynchronous indication may be used). At communication 316 a Download Request may be sent. At communication 318, a client streamer module component may start downloading from the surrogate server. At communication 320 streamer #1 module may provide media data to the scheduler module (e.g. one call per chunk).

At communication 322, the MN may be attached to AN2. At communication 324 the attachment may be detected by the scheduler module. The scheduler module may start a new/different streamer module to prepare for possible handover (or, in case AN2 is preferred, to switch over to using AN2, perhaps immediately). At communication 326, a Session Init Request may be sent. At communication 328 a streaming session may be initiated, which may be a DNS resolution (in some embodiments, marked nodes may or may not participate, depending on CDN redirection method). At communication 330, streamer #2 module may indicate it is ready to download. At communication 332, perhaps based on local policy (and possibly user input) the scheduler module may select which streamer to use—in this example, it stays on streamer #1 module. At communication 334, the MN may lose attachment to AN1. At communication 336, streamer #1 module may provide a last partial media data to the scheduler module. At communication 338 the scheduler module may detect loss of attachment and may switch over to streamer #2 module. The scheduler module may terminate streamer #1 module instance. At communication 340, a Download Request may be sent. At communication 342, the client streamer module component may start downloading from surrogate server 2 (using Range: to resume downloading from where it stopped, for example). At communication 344, Streamer #2 may provide media data to Scheduler (e.g. one call per chunk). At communication 346 Scheduler may continue receiving data from streamer #2 module. The scheduler module may check network adapters.

Embodiments contemplate that progressive download can be supported in the way similar to the HTTP adaptive streaming case described previously. One or more embodiments contemplate that some form of segmentation may be useful to enable active aggregation. For example, HTTP byte ranges may be used to divide the file in 100 kBytes data pieces that can be retrieved individually. An example can be derived from FIG. 32: in point circle-32008 of this figure, in the Progressive HTTP Download case, the scheduler may distribute requests for data pieces of 100 kBytes to the streamers, using a scheduling algorithm such as one of the variants described previously.

Embodiments contemplate RTP Based Streaming handover and aggregation. With respect to mobile session continuity, RTSP/RTP/RTCP based streaming may be supported in the way similar to the HTTP adaptive streaming case described previously in regard to FIG. 33. In one or more embodiments, the following differences apply: Session initialization (circle-33004 and circle-33010) may include DNS resolution, followed by metadata download. This metadata may be obtained through HTTP, or through the RTSP DESCRIBE method, for example. One or more embodiments contemplate that, just like in the Adaptive HTTP Streaming case, any of these individual actions may be used in the CDN redirection process.

One or more embodiments contemplate that, perhaps after a mobility event, the scheduler may request the new/different streamer to start streaming from the point where the stream was interrupted. This can be done using a “Range:” header in the RTSP PLAY method. For example, at the beginning of the streaming session at circle-33006, the first streamer module may use the following PLAY command:

### Client→Server:

PLAY rtsp://audio.example.com/audio RTSP/1.0
CSeq. 12
Session: 12345678

The first access network attachment may be lost; a new/different IP address may be obtained from another access network; the scheduler may note that the stream was interrupted at start+340 seconds. The scheduler may request at circle-32012 the new/different streamer module instance to start at that position in the stream. The resulting PLAY command may be:

### Client→Server:

PLAY rtsp://audio.example.com/audio RTSP/1.0
CSeq: 12
Session: 12345679
Range: npt=340-

One or more embodiments contemplate that the first PLAY method sent by a given streamer module to a given surrogate streaming server may be preceded by a SETUP method.

As in the case of Progressive HTTP Streaming, one or more embodiments contemplate that some form of segmentation may be useful for streaming aggregation to take place. An example can be derived from FIG. 32, in point circle-32008 of this figure, in the RTPS/RTP/RTCP case, the scheduler may decide to request the audio component from one streamer module, and the video component from another streamer module (some streamer modules or every streamer module may send a different RTSP PLAY method, requesting stream for one component or the other). Alternatively or additionally, one or more embodiments contemplate that the scheduler module may instead distribute requests for “segments” of 10 seconds to the streamers, using a scheduling algorithm such as one of the variants described previously. Inside the streamer module instances, the 10 seconds segments may be requested using individual RTSP PLAY methods using the “Range:” header to select a given 10 seconds section of the stream, for example.

In light of the description herein, one or more embodiments contemplate one or more methods that may comprise detecting movement of a mobile node (MN) from a first access network to a second access network. The MN may be in communication with a first content delivery network (CDN-1) server. The CDN-1 server may be in communication with a first content delivery network (CDN-1). The method may further include determining an effect on server selection as a result of the movement and initiating a transfer from the CDN-1 server to a second content delivery network (CDN-2) server, based at least in part, on the determination of the effect the server selection the CDN-2 server being in communication with a second content delivery network (CDN-2).

Embodiments contemplate that the determining the effect on server selection may include a comparison of a measured quality of service with a predetermined quality of service and that the initiating the transfer may be further based on the measured quality of service being less than the predetermined quality of service. Alternatively or additionally, embodiments contemplate that the determining the effect on server selection may include a comparison of an estimated cost of delivery to a predetermined cost of delivery.

Embodiments contemplate that prior to the transfer the MN may receive an application stream via the CDN-1 server and the transfer may include redirecting the application stream to the MN via the CDN-2 server. Alternatively or additionally, embodiments contemplate the one or more methods may include sending a first message to the CDN-2. The first message may include a request for an updated routing for the application stream. Embodiments also contemplate the methods may include receiving a second message from the CDN-2. The second message may include an updating routing for the application stream. Also, embodiments contemplate that the initiating the transfer may include sending a third message to a source of the application stream. The third message may include the updated routing information for the application stream.

Embodiments also contemplate that the CDN-1 and the CDN-2 may be in communication with a third content delivery network (CDN-3), and the methods may further comprise sending a fourth message to the CDN-3. The fourth message may include an indication of the transfer. The methods may also include receiving a fifth message from the CDN-3. The fifth message may include an acknowledgment of the indication of the transfer.

Alternatively or additionally, embodiments contemplate that the methods may further comprise sending a first message to the CDN-3. The first message may include a request for an updated routing for the application stream. Embodiments contemplate that the methods may include receiving a second message from the CDN-3. The second message may include an updating routing for the application stream. Embodiments also contemplate that the initiating the transfer may include sending a third message to a source of the application stream, where the third message may include the updated routing information for the application stream.

Alternatively or additionally, embodiments contemplate that the initiating the transfer may include sending at least one command for an application specific transfer. Embodiments contemplate that the application may include at least one of Adaptive Hyper Text Transport Protocol (HTTP) Streaming, Real Time Streaming Protocol (RTSP), or HTTP Progressive Download streaming.

One or more embodiments contemplate one or more methods that may comprise detecting movement of a mobile node (MN) from a first access network to a second access network. The MN may be in communication with a first content delivery network (CDN-1) server, and the CDN-1 server may be in communication with a first content delivery network (CDN-1). Embodiments contemplate that the methods may include determining an effect on server selection as a result of the movement. Further, embodiments contemplate that the methods may include initiating a transfer from the CDN-1 server to an application server, based at least in part, on the determination of the effect the server selection. The MN may receive an application stream from the application server via the CDN-1 server prior to the transfer.

Alternatively or additionally, embodiments contemplate that the CDN-1 may be in communication with a second content delivery network (CDN-2), and the methods may further comprise sending a first message to the CDN-2. The first message may include a request for an updated routing for the application stream. Embodiments also contemplate that the methods may include receiving a second message from the CDN-2. The second message may include a redirection to the application server.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer- readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, comprising:
detecting movement of a first mobile node (MN) from a first access network to a second access network, the first MN being in communication with a first content delivery network (CDN-1) server, the CDN-1 server being in communication with a first content delivery network (CDN-1), the first MN receiving an application stream via the CDN-1 server;
determining an effect on server selection as a result of the movement;
initiating a transfer from the CDN-1 server to a second content delivery network (CDN-2) server, based at least in part, on the determination of the effect the server selection, the CDN-2 server being in communication with a second content delivery network (CDN-2), the transfer including redirecting the application stream via the CDN-2 to a second mobile node (MN), the CDN-1 and the CDN-2 being in communication with a third content delivery network (CDN-3), the CDN-3 including a source of the application stream;
sending a first message to the CDN-3, the first message being a content delivery network interconnection (CDNI) type message and including an indication of the transfer; and
receiving a second message from the CDN-3, the second message being a content delivery network interconnection (CDNI) type message and including an acknowledgment of the indication of the transfer.

2. The method of claim 1, wherein the determining the effect on server selection includes a comparison of a measured quality of service with a predetermined quality of service.

3. The method of claim 2, wherein the initiating the transfer is further based on the measured quality of service being less than the predetermined quality of service.

4. The method of claim 1, wherein the determining the effect on server selection includes a comparison of an estimated cost of delivery to a predetermined cost of delivery.

5. (canceled)

6. The method of claim 1, further comprising:
sending a third message to the CDN-2, the third message including a request for an updated routing for the application stream; and
receiving a fourth message from the CDN-2, the fourth message including an updated routing for the application stream, wherein the initiating the transfer includes sending a fifth message to the source of the application stream, the fifth message including the updated routing information for the application stream.

7. (canceled)

8. The method of claim 1, further comprising:
sending a third message to the CDN-3, the third message including a request for an updated routing for the application stream; and
receiving a fourth message from the CDN-3, the fourth message including an updated routing for the application stream, wherein the initiating the transfer includes sending a fifth message to the source of the application stream, the fifth message including the updated routing information for the application stream.

9. The method of claim 1, wherein the initiating the transfer includes sending at least one command for an application specific transfer, the application including at least one of Adaptive Hyper Text Transport Protocol (HTTP) Streaming, Real Time Streaming Protocol (RTSP), or HTTP Progressive Download streaming.

10. A method, comprising:
detecting movement of a mobile node (MN) from a first access network to a second access network, the MN being in communication with a first content delivery network (CDN-1) server, the CDN-1 server being in communication with a first content delivery network (CDN-1);
determining an effect on server selection as a result of the movement; and
initiating a transfer from the CDN-1 server to an application server, based at least in part, on the determination of the effect the server selection, the MN receiving an application stream from the application server via the CDN-1 server prior to the transfer.

11. The method of claim 10, wherein the CDN-1 is in communication with a second content delivery network (CDN-2), the method further comprising:
sending a first message to the CDN-2, the first message including a request for an updated routing for the application stream; and
receiving a second message from the CDN-2, the second message including a redirection to the application server.

12. The method of claim 10, wherein the determining the effect on server selection includes a comparison of a measured quality of service with a predetermined quality of service.

13. The method of claim 1, wherein the determining the effect on server selection includes a comparison of an estimated cost of delivery to a predetermined cost of delivery.

14. An apparatus, comprising:
a wireless network interface device having a communications protocol module configured to establish a network attachment to a wireless network;
a streaming module configured to receive a content delivery network (CDN) surrogate server address and request portions of media content using the wireless network interface and the CDN surrogate server address; and
a connection manager component configured to detect a network attachment notification associated with the wireless network interface device and to responsively initiate a CDN surrogate identification process.

15. The apparatus of claim 14, wherein the connection manager component is further configured to initiate a CDN surrogate identification process by, at least in part, requesting the streaming module to initiate a domain name service (DNS) request for a name associated with the portions of media content.

16. The apparatus of claim 15, wherein the DNS request is invoked with a DNS server address parameter.

17. The apparatus of claim 15, wherein the DNS request is invoked with an indication to not use a DNS cache.

18. The apparatus of claim 15, wherein the domain name service provides a local cache with entries having at least a local/global indicator parameter.

19. The apparatus of claim 14, further comprising a plurality of wireless network interface devices, each of the plurality of wireless network interface devices having at least one associated streamer module, and wherein each streamer module is configured to use a CDN surrogate server address associated with its respective network interface.

20. The apparatus of claim 19, further comprising a scheduler module configured to allocate requests for portions of media content to the least one associated streamer module for each wireless network interface device.
